(19) United States
(12) Patent Application Publication
(10) Pub. No.: US 2018/0181989 A1
(43) Pub. Date: Jun. 28, 2018

(54) DISTRIBUTION METHOD AND DISTRIBUTION MANAGEMENT SYSTEM FOR PROMOTION POINT HAVING UNIT OF TIME

(71) Applicant: ADA ZERO INC., Tokyo (JP)

(72) Inventors: Sung Sam Yoo, Tokyo (JP); Takeyuki Kimura, Tokyo (JP)

(21) Appl. No.: 15/524,134

(22) PCT Filed: May 15, 2015
(86) PCT No.: PCT/KR2015/004896

§ 371 Date: Feb. 8, 2018

(30) Foreign Application Priority Data
Nov. 6, 2014 (JP) 2014-226531

(51) Int. Cl. G06Q 30/02

(52) U.S. Cl. CPC G06Q 30/0259; G06Q 30/0264; G06Q 30/0272; G06Q 30/0267; G06Q 30/0261; G06Q 30/0277

(57) ABSTRACT

In one embodiment, a method for controlling a time point distribution management network/system for distributing an electronic sales promotion point in a unit of time is provided. A predetermined elapsed period of time of a user in a member store is measured by a dedicated application while monitoring a radio wave which is transmitted from a location notifying device installed in the member store, by means of a radio wave detector of the client device, and an issuing condition of the member store is a condition that a time point whose issue number is based on the same unit as a unit of the time measured by the dedicated application is issued. Furthermore, a consumption condition of the affiliated store is calculated by a sale price of the affiliated store with respect to the predetermined sales promotion time.

### TECHNICAL FIELD

The present disclosure relates to a technology for distributing sales promotion points through a network.

### BACKGROUND ART

For the purpose of sales promotion, a particular store or shopping street, etc., is providing a service for issuing a sales promotion point when a user visits the store or purchases goods, etc.

Generally, since the sales promotion point is issued according to a selling price, the issuer of the sales promotion point provides a point/service in which the point is issued according to the selling price by installing a point issuing device and associating it with a POS system which performs management of a time point of sales, or by issuing a membership card (a magnetic or IC card, etc.) for authorizing a user, and by causing the point issuing device to read the membership card presented by the user who visits a store or purchase goods, and then the corresponding issued data is recorded by means of a point management system of a center through Internet, etc., so that, when the user purchases goods next time, the corresponding issued sales promotion point is used for discount, etc., only by being presented with the membership card from the user.

Recently, with the expansion of Internet infrastructures, the performance of a mobile terminal (smartphone or tablet PC, etc.) is being rapidly evolved. Also, a variety of applications for the mobile terminal are being developed by means of well-known HTML and a programming language such as JavaScript, PHP, Perl, Java, C, C++, etc. Together with the development of the applications, a business operator providing the point/service begins to spread an application dedicated to the management of the sales promotion point.

This dedicated application is installed in a smartphone (mobile phone) by a user himself/herself through the Internet. The application enables the business operator providing the point/service to provide sales promotion points to the user without installing the point issuing device or without issuing a membership card at a certain cost and enables the user to check the balance of the sales promotion point, event information of the issuing store, etc., at any time. The great contribution of the application to the spread of the point/service begins to be known.

The inventor of the present application has already disclosed a technology for distributing such a sales promotion electronic point through a patent application (Japanese Patent Application Laid-open No. Hei 10-139056, May 21, 1998) related to ┌electronic chip distributing method, electronic chip distributing server, and electronic chip distributing system┘, and has described in detail that the sales promotion electronic chip (point) is distributed by a method disclosed in claim 1 of the patent application, which relates to the electronic chip distributing method for distributing the electronic chip, the method comprising: issuing an electronic chip on the basis of a set condition of issuing the electronic chip with respect to a predetermined issuing operation by a user; accepting consumption of the electronic chip on the basis of a set condition of consuming the electronic chip with respect to a predetermined consuming operation by the user; supplying the user with information on the electronic chips owned by the user, as electronic chip information; managing an issue history of the electronic chip and a consumption history of the electronic chip; and calculating the condition of issuing the electronic chip and the condition of consuming the electronic chip on the basis of the issue history of the electronic chip and the consumption history of the electronic chip. Therefore, by applying this technology to the aforementioned dedicated application, it is possible to convert a particular sales promotion electronic point into another sales promotion point, to use the sales promotion point to purchase goods and use the service in other stores, and to participate in games, etc., without being limited to the discount by the store that has issued the sales promotion point. A new point/service based on this technology begins to rise.

The technology which is used in such a service can be implemented by applying a client/server technology disclosed in the aforementioned patent application ┌electronic chip distributing method, electronic chip distributing server, and electronic chip distributing system┘ by the inventor of the present application to an application dedicated to a mobile terminal and a point management server, etc. It is clear in terms of economic principles that ┌a conversion rate between a unit of the electronic chip and a unit of currency┘ disclosed in Claim 3 of the patent application ┌The method according to claim 1, wherein the condition of consuming the electronic chip comprises the conversion rate between a unit of the electronic chip and a unit of money, and comprises a valid period of the electronic chip┘ is indispensable in the background where the point distribution is implemented.

However, in the distribution of the sales promotion point based on the ┌conversion rate between a unit of the electronic chip and a unit of currency┘, a financial settlement process according to the consumption points of each user is always required between the issuer of the sales promotion point and the consumption provider of the sales promotion point. It goes without saying that the settlement process requires a large-scale system and a high cost. In fact, such a point conversion (distribution) is operated by a large capital, and small-cap stores or shopping streets, etc., pay a relatively high cost for use of the sales promotion point.

As described above, originally, under a condition that a particular store or shopping street, etc., is an issuer of the sales promotion point, the sales promotion point has developed as an effective means for sales promotion in the store itself. Here, with the expansion of Internet and digitization of evolution of a terminal technology, the sales promotion point begins to be distributed regardless of the will of the issuer before we know, and is being changed into a profit tool of a point/service operating company based on a large capital.

Meanwhile, social aging or reduction in the number of children causes the impoverishment of a local economy. Here, the small-cap stores or shopping streets, etc., begin to rapidly decline, and people who have difficulty in shopping are significantly increasing in a local area. However, these stores and shopping streets are very closely associated with local residents, and in particular, are expected to be a community hub of aged people having a lot of available free time. Therefore, there is a requirement for a policy (technology) for strengthening the existence of the stores and shopping streets.

### DISCLOSURE

### Technical Problem

The present invention is intended to solve the above problems. The object of the present invention is to ensure that, in stores or shopping streets, etc., which are very closely associated with residents, sales promotion electronic points which are issued or consumed under a “time”-related predetermined condition are converted (distributed) according to the resident's (user's) value for time, so that satisfaction with the goods and services of each store are complemented with each other. Also, the object of the present invention is to ensure that a sales promotion point which is based on a unit of time and achieves the original purpose thereof is provided to small-cap and small size stores or shopping streets, etc., that are forced to pay for the point which is designed for discount and is issued by the consumption of the resident.

### Technical Solution

One embodiment is a method for controlling a time point distribution management network/system for distributing an electronic sales promotion point in a unit of time by a Web client/server system using an internet communication. A server system which is used in the time point distribution management network/system is a time management system which comprises not only a database for managing a user, the time point, and a time measurement place, but also an authentication processing program for authorizing the user and the time measurement place, a point management program for managing a time point issue history or a time point consumption history, and a condition management program for managing a time point issuing condition or a time point consumption condition. A client device which is used in the time point distribution management network/system has a function of a general-purpose computer on which a dedicated application composed of a reception measurement program for performing a time measurement while detecting the time measurement place, a point issuing program for performing an issuance of the time point, and a point consuming program for performing a consumption of the time point has been installed. Through the internet communication between the time management system and the client device, the method for controlling a time point distribution management network/system comprises: (a) providing the user with information on a member store issuing the time point, the time point issuing condition of the member store, information on an affiliated store in which the time point is consumed, or the time point consumption condition of the affiliated store; (b) issuing the time point on the basis of the issuing condition in accordance with a predetermined elapsed period of time of the user in the member store; (c) accepting the consumption of the time point on the basis of the consumption condition in accordance with a predetermined sales promotion time of the user in the affiliated store; (d) processing the issuance or consumption of the time point, or managing the time point issue history or the time point consumption history; and (e) providing the user with information on the time point that the user possesses. The predetermined elapsed period of time of the user in the member store is measured by the dedicated application while monitoring a radio wave, which is transmitted from a location notifying device installed in the member store, by means of a radio wave detector of the client device, and the issuing condition of the member store is a condition that the time point whose issue number is based on the same unit as a unit of the time measured by the dedicated application is issued.

The time point which is issued by the issuing condition of the member store is consumed on the basis of the consumption condition calculated by a sale price of the affiliated store with respect to the predetermined sales promotion time in the affiliated store.

The client device is equipped with a GPS receiver and a location measurement program is added to a program constituting the dedicated application which is installed on the client device, so that the predetermined elapsed period of time of the user in the member store is measured by the dedicated application while obtaining a positioning data of a current location based on a GPS function.

One or both of the member store and the affiliated store is a net-based service provider which operates a Web service system, and not only a predetermined elapsed period of time related to a particular operation of the user for the Web service system is measured by a Web-API exchange between the Web service system and the time management system, but also the time point is issued or consumed on the basis of the measured time.

The predetermined elapsed period of time related to a particular operation of the user is an elapsed time period from an order time for an order operation for a net shop by the user to an arrival time of an ordered goods.

The predetermined elapsed period of time related to a particular operation of the user is an elapsed time period from a play start time for a play operation for a net game by the user to a play end time.

The predetermined elapsed period of time related to a particular operation of the user is an elapsed time period from a view start time for a view operation for a net advertisement by the user to a view end time.

The client device is equipped with a radio wave detector having a location detection function, and a location of the client device is detected by the location detection function of the radio wave detector of the client device.

Another embodiment is a method for controlling a time point distribution management network/system for distributing an electronic sales promotion point in a unit of time by a Web client/server system using an internet communication by using a client device. The client device has a function of a general-purpose computer on which a dedicated application composed of a reception measurement program for performing a time measurement while detecting a time measurement place, a point issuing program for performing an issuance of the time point, and a point consuming program for performing a consumption of the time point has been installed. The method for controlling a time point distribution management network/system comprises: (a) providing a user with information on a member store issuing the time point, a time point issuing condition of the member store, information on an affiliated store in which the time point is consumed, or a time point consumption condition of the affiliated store; (b) issuing the time point on the basis of the issuing condition in accordance with a predetermined elapsed period of time of the user in the member store; and (c) providing the user with information on the time point that the user possesses. The predetermined elapsed period of time is measured by the dedicated application while monitoring a radio wave, which is transmitted from a location notifying device installed in the member store, by means of a radio wave detector of the client device, and the issuing condition is a condition that the time point whose issue number is based on the same unit as a unit of the time measured by the dedicated application is issued.

The time point which is issued by the issuing condition of the member store is consumed on the basis of the consumption condition calculated by a sale price of the affiliated store with respect to the predetermined sales promotion time in the affiliated store.

The client device is equipped with a GPS receiver and a location measurement program is added to a program constituting the dedicated application which is installed on the client device, so that the predetermined elapsed period of time in the member store is measured by the dedicated application while obtaining a positioning data of a current location based on a GPS function.

One or both of the member store and the affiliated store is a net-based service provider which operates a Web service system, and not only the predetermined elapsed period of time is measured by a Web-API exchange between the Web service system and the time management system, i.e., an external server, but also the time point is issued or consumed on the basis of the measured time.

Further another embodiment is a method for controlling a time point distribution management network/system for distributing an electronic sales promotion point in a unit of time by using a server system. The server system comprises not only a database for managing a user, the time point, and a time measurement place, but also an authentication processing program for authorizing the user and the time measurement place, a point management program for managing a time point issue history or a time point consumption history, and a condition management program for managing a time point issuing condition or a time point consumption condition. The method for controlling a time point distribution management network/system comprises: (a) providing the user with information on a member store issuing the time point, the time point issuing condition of the member store, information on an affiliated store in which the time point is consumed, or the time point consumption condition of the affiliated store; (b) issuing the time point on the basis of the issuing condition in accordance with a predetermined elapsed period of time of the user in the member store; (c) accepting the consumption of the time point on the basis of the consumption condition in accordance with a predetermined sales promotion time of the user in the affiliated store; (d) processing the issuance or consumption of the time point, or managing the time point issue history or the time point consumption history; and (e) providing the user with information on the time point that the user possesses. The predetermined elapsed period of time of the user in the member store is measured by a dedicated application while monitoring a radio wave, which is transmitted from a location notifying device installed in the member store, by means of a radio wave detector of a client device, and the issuing condition of the member store is a condition that the time point whose issue number is based on the same unit as a unit of the time measured by the dedicated application is issued.

One or both of the member store and the affiliated store is a net-based service provider which operates a Web service system, and not only a predetermined elapsed period of time related to a particular operation of the user for the Web service system is measured by a Web-API exchange between the Web service system and the time management system, but also the time point is issued or consumed on the basis of the measured time.

The predetermined elapsed period of time related to a particular operation of the user is an elapsed time period from an order time for an order operation for a net shop by the user to an arrival time of an ordered goods.

The predetermined elapsed period of time related to a particular operation of the user is an elapsed time period from a play start time for a play operation for a net game by the user to a play end time.

The predetermined elapsed period of time related to a particular operation of the user is an elapsed time period from a view start time for a view operation for a net advertisement by the user to a view end time.

The time point which is issued by the issuing condition of the member store is consumed on the basis of the consumption condition calculated by a sale price of the affiliated store with respect to the predetermined sales promotion time in the affiliated store.

Yet another embodiment is a time point issuing method for distributing an electronic sales promotion point in a unit of time by a Web client/server system using an internet communication. A server system which is used in the time point distribution management network/system is a time management system which comprises not only a database for managing a user, the time point, and a time measurement place, but also an authentication processing program for authorizing the user and the time measurement place, a point management program for managing a time point issue history, and a condition management program for managing a time point issuing condition. A client device which is used in the time point distribution management network/system has a function of a general-purpose computer on which a dedicated application composed of a reception measurement program for performing a time measurement while detecting the time measurement place, and a point issuing program for performing an issuance of the time point has been installed. Through the internet communication between the time management system and the client device, the method for distributing an electronic sales promotion point comprises: (a) providing the user with information on a member store issuing the time point, or the time point issuing condition of the member store; (b) issuing the time point on the basis of the issuing condition in accordance with a predetermined elapsed period of time of the user in the member store;

(c) processing the issuance of the time point, or managing the time point issue history; and (d) providing the user with information on the time point that the user possesses. The predetermined elapsed period of time of the user in the member store is measured by the dedicated application while monitoring a radio wave, which is transmitted from a location notifying device installed in the member store, by means of a radio wave detector of the client device, and the issuing condition of the member store is a condition that the time point whose issue number is based on the same unit as a unit of the time measured by the dedicated application is issued.

The client device is equipped with a GPS receiver and a location measurement program is added to a program constituting the dedicated application which is installed on the client device, so that the predetermined elapsed period of time of the user in the member store is measured by the dedicated application while obtaining a positioning data of a current location based on a GPS function.

One or both of the member store and the affiliated store is a net-based service provider which operates a Web service system, and not only a predetermined elapsed period of time related to a particular operation of the user for the Web service system is measured by a Web-API exchange between the Web service system and the time management system, but also the time point is issued on the basis of the measured time.

The predetermined elapsed period of time related to a particular operation of the user is an elapsed time period from an order time for an order operation for a net shop by the user to an arrival time of an ordered goods.

The predetermined elapsed period of time related to a particular operation of the user is an elapsed time period from a play start time for a play operation for a net game by the user to a play end time.

The predetermined elapsed period of time related to a particular operation of the user is an elapsed time period from a view start time for a view operation for a net advertisement by the user to a view end time.

The client device is equipped with a radio wave detector having a location detection function, and a location of the client device is detected by the location detection function of the radio wave detector of the client device.

Still another embodiment is a time point consuming method for distributing an electronic sales promotion point in a unit of time by a Web client/server system using an internet communication. A server system which is used in the time point distribution management network/system is a time management system which comprises not only a database for managing a user, the time point, and a time measurement place, but also an authentication processing program for authorizing the user and the time measurement place, a point management program for managing a time point consumption history, and a condition management program for managing a time point consumption condition. Through the internet communication between the time management system and the client device, the method for distributing an electronic sales promotion point comprises: (a) providing the user with information on an affiliated store in which the time point is consumed, or the time point consumption condition of the affiliated store; (b) accepting the consumption of the time point on the basis of the consumption condition in accordance with a predetermined sales promotion time of the user in the affiliated store; (c) processing the consumption of the time point, or managing the time point consumption history; and (d) providing the user with information on the time point that the user possesses.

The time point is consumed on the basis of the consumption condition calculated by a sale price of the affiliated store with respect to the predetermined sales promotion time in the affiliated store.

Still another embodiment is a time point issuing method for distributing an electronic sales promotion point in a unit of time by a Web client/server system using an internet communication. A server system which is used in the time point distribution management network/system is a time management system which comprises not only a database for managing a user, the time point, and a time measurement place, but also an authentication processing program for authorizing the user and the time measurement place, a point management program for managing a time point issue history, and a condition management program for managing a time point issuing condition. Through the internet communication between the time management system and the client device, the method for distributing an electronic sales promotion point comprises: (a) providing the user with information on a member store issuing the time point, or the time point issuing condition of the member store; (b) accepting an issuance the time point on the basis of the issuing condition in accordance with a predetermined elapsed period of time of the user in the member store; (c) processing the issuance of the time point, or managing the time point issue history; and (d) providing the user with information on the time point that the user possesses.

The predetermined elapsed period of time is measured on the basis of a sound wave which is transmitted from a location notifying device installed in the member store.

The client device which is used in the time point distribution management network/system has a function of a general-purpose computer on which a dedicated application composed of a reception measurement program for performing a time measurement while detecting the time measurement place, and a point issuing program for performing an issuance of the time point has been installed. The client device measures the predetermined elapsed period of time through the dedicated application while monitoring the sound wave which is transmitted from the location notifying device.

The issuing condition is a condition that the time point whose issue number is based on the same unit as a unit of the time measured by the dedicated application is issued.

### Advantageous Effects

According to the embodiment of the present invention, it is possible to ensure that, in stores or shopping streets, etc., which are very closely associated with residents, sales promotion electronic points which are issued or consumed under a “time”-related predetermined condition are converted (distributed) according to the resident's (user's) value for time, so that satisfaction with the goods and services of each store are complemented with each other. Also, it is possible to ensure that a sales promotion point which is based on a unit of time and achieves the original purpose thereof is provided to small-cap and small size stores or shopping streets, etc., that are forced to pay for the point which is designed for discount and is issued by the consumption of the resident.

### DESCRIPTION OF DRAWINGS

FIG. 1 is an outline view of a first embodiment;

FIG. 2 shows a predetermined issuing operation by a user;

FIG. 3 shows a predetermined consuming operation by a user;

FIG. 4 is an outline view of user registration;

FIG. 5 is an outline view of registration and provision of an ┌member store guide┘;

FIG. 6 is an outline view of registration and provision of a ┌guide to the use of affiliated store┘;

FIG. 7 shows a configuration of an affiliation between the member store and the affiliated store;

FIG. 8 is an outline view of issuance and use of a sales promotion use ticket;

FIG. 9 shows a configuration of a time measurement using a GPS function;

FIG. 10 shows data for Web-API (Google, Inc.);

FIG. 11 is an outline view of an embodiment (highway) using the GPS function;

FIG. 12 is an outline view of a second embodiment (net shop);

FIG. 13a is an outline view of the second embodiment (net advertisement);

FIG. 13b is a partial enlarged view of the outline view of the second embodiment (net advertisement);

FIG. 14a is an outline view of the second embodiment (net game);

FIG. 14b is a partial enlarged view of the outline view of the second embodiment (net game);

FIG. 15 shows a user management database record layout;

FIG. 16 shows a member store management database record layout;

FIG. 17 shows an affiliated store management database record layout;

FIG. 18 shows a member store guide database record layout;

FIG. 19 shows an affiliated store guide database record layout;

FIG. 20 shows a location notifying device database record layout;

FIG. 21 shows a point management database record layout; and

FIG. 22 shows a sales promotion ticket management database record layout.

### BEST MODE

### Outline of the Invention

The present invention is based on the premise of a technology for distributing sales promotion points through a network. A first embodiment of the present invention is that the sales promotion point is a time point which is issued or consumed by measuring a predetermined period of time at a particular place.

First, in a predetermined issuing operation by a user, a period of time is measured based on a set time measurement condition.

Specifically, for example, when a user visits a particular store, facility, etc., in possession of a client device, e.g., a smartphone (a mobile phone) or a tablet PC, etc., in which an application dedicated for managing information on the issuance of the sales promotion point has been installed and which has a function of detecting a Bluetooth radio wave, a Bluetooth radio wave transmitted from a location notifying device installed in the store, facility, etc., is detected by the client device. Then, (1) a time period from when the user visits the store to when the user leaves the store (2) a time period from when the user orders a particular service or goods to when the service or goods is provided to the user, or (3) a time period which excesses a commonly required time period is measured, and time measurement data related to the measured time period is transmitted from the client device to a time management system of a point management center through Internet. Then, the time point is issued according to a predetermined issuing condition based on the transmitted time measurement data.

In addition, it can be considered that the condition of issuing the time point includes a user attribute (depending on personal information, etc., combined with user ID), a valid period of the corresponding time point, and an issuing place (depending on identification information of the location notifying device), etc.

Next, in a predetermined consuming operation by the user, a period of time is measured based on a set condition of measuring time.

Specifically, for example, the user when the user visits a particular store, facility, etc., in possession of a client device, e.g., a smartphone (a mobile phone) or a tablet PC, etc., in which an application dedicated for managing information on the consumption of the sales promotion point has been installed and which has a function of detecting a Bluetooth radio wave, a Bluetooth radio wave transmitted from a location notifying device installed in the store, facility, etc., is detected by the client device. Then, (1) a time period from when the user visits the store to when the user leaves the store (2) a time period from when a particular service is initiated to when the service is ended, or (3) a time period which excesses a normal service time is measured, and time measurement data related to the measured time period is transmitted from the client device to a time management system of a point management center through the Internet. Then, the time point is consumed according to a predetermined consumption condition based on the transmitted time measurement data.

In addition, there is a case where the condition of consuming the time point includes a user attribute (depending on personal information, etc., combined with user ID), a valid period of the corresponding time point, and an issuing place (depending on identification information of the location notifying device), etc.

Also, information on the time point (the balance of the point, the valid period, the conversion rate, etc.) that the user possesses is provided as time point information to the user.

Also, the time point issued according to the predetermined issuing condition and the time point consumed according to the predetermined consumption condition, which are based respectively on the time measurement data transmitted to the time management system from the client device by the issuing operation and consuming operation by the user, are time point issue history data and time point consumption history data, respectively. They are recorded in a point management database by a database management server device.

First, in the predetermined issuing operation by the user, a time point issuing module within the time management system issues (adds) the time point on the basis of the time measurement data transmitted from the client device, the identification information (identification information of either the client device or a dedicated application installed in the client device, etc.) of the user who has performed the operation, and the condition of issuing the time point. Also, a history of the predetermined issuing operation by the user is managed. Further, the information on the time point that the user possesses is supplied as the time point information to the client device by the time point information supply module.

Next, in the predetermined consuming operation by the user, a time point consumption module within the time management system consumes (reduces) the time point on the basis of the time measurement data transmitted from the client device, the identification information (identification information of either the client device or a dedicated application installed in the client device, etc.) of the user who has performed the operation, and the condition of consuming the time point. Also, a history of the predetermined consuming operation by the user is managed. Further, the information on the time point that the user possesses is supplied as the time point information to the client device by the time point information supply module.

Here, in a case where the time point issued by the predetermined issuing operation by the user and the time point consumed by the predetermined consuming operation by the user are understood as a conventional sales promotion point, the conversion rate should be necessarily 1:1 in a unit thereof (e.g., which corresponds to “Yen” in a monetary unit, “Km” in the unit of distance, or “Minute” in the unit of time). This is what is called a conventional technology related to a common point. This will be described by an example. For instance, when a particular issuer pays a point management business operator a cost based on a conversion rate between the issued sales promotion points and money and then the user consumes the sales promotion points in a particular consumption provider, the point management business operator pays the consumption provider a cost based on a conversion rate between money and the sales promotion points used in the consumption. This shows the configuration of the technology for allowing the consumption provider to implement a discount, etc., for users. However, in a service model adopting the common point based on the conventional technology, small size stores, specialty stores, etc., having limited goods or services are able to make an affiliation with each other by means of the common point, and thus, it is said that the user's feeling of satisfaction with the sales promotion service is increased. However, a processing fee or system fee for the issuance or consumption of the sales promotion point is expensive to the point management business operator (generally, 1 to 2% of turnover caused by the issuance of the sales promotion point). Also, the amount of the issued sales promotion points does not achieve a balance with user's revisiting the store. That is, the user is apt to visit a place having a better condition of consuming the sales promotion point, and the sales promotion point issuing store cannot necessarily expect the user's revisiting the store, which is appropriate for the amount of the issued sales promotion points. Therefore, there is a disadvantage in that the cost of issuing the sales promotion point is regarded as a burden by the sales promotion point issuing store.

In order to overcome such disadvantages of the conventional technology, the present invention provides a technology for not only specifying the condition of issuing the sales promotion point on the basis of a physical relative value of “time” but also for calculating the condition of consuming the sales promotion point in accordance with a sale price standard related to “sales promotion time”.

That is to say, the present invention provides a technology in which the sales promotion point is not issued according to a price at which the user purchases the goods by the issuer but a point distribution center (a third party) which operates the time management system issues the time point on the basis of “time” based on the predetermined issuing operation by the user, and also, the conversion rate (i.e., the conversion (consumption) condition between the time point and the goods or services for sales promotion which are provided to the user by the consumption provider) is calculated in accordance with the sale price standard related to the “sales promotion time” by the consumption provider, and the point distribution center appeals this sales promotion information (for example, spreads by means of an e-mail, etc.) to the user (owner of the time point), so that a balance is achieved between a cost for the goods or services for sales promotion which are provided by the consumption provider and a cost for issuing the time point by the issuer. In a service model adopting the common point based on the technology, goods or services of the issuer and the consumption provider can be mutually complemented with unlimited zeroization of the cost for issuing the time point and it is possible to significantly increase the user's satisfaction with the sales promotion service.

Therefore, in the present invention, as described above, the conversion rate between the time point issued by the predetermined issuing operation by the user and the time point consumed by the predetermined consuming operation by the user is not necessarily 1:1 in a unit thereof and is fundamentally different from that of the conventional technology related to the common point.

That is, the time point which is issued by the predetermined issuing operation by the user is issued in accordance with a predetermined elapsed period of time of the user in the issuer. Such a time point is a physical relative value of “time”, which is not based on the premise of a conversion between the time point and money. For example, when 1TP (TP is a unit of the time point) is issued for the predetermined elapsed period of time of 1 minute, facilities-based service providers (who operates an amusement place such as a singing room, theater, resort, game center, etc.) or treatment-based service providers (who operates a beauty parlor, aesthetic shop, massage clinic, etc.) are able to encourage the user to visit the store by providing the “sales promotion time” such as the increase of “service time”, the provision of a “trial period”, reduction of a “waiting time” (prior entry), or the like, in accordance with the number of the time points, without encouraging the user to visit the store by discounting the use fee, sale price, etc. Moreover, since there is no necessity to pay a particular cost for the sales promotion (the discount is a substantive sales promotion cost), they are expected to participate as a consumption provider in a time point distribution management network and system according to the embodiment of the present invention. These consumption providers have different sale price standards of the “sales promotion time” (that is, a general use fee, a general sale price, etc., per a unit time of the “sales promotion time” in the consumption provider) respectively. Therefore, for example, the universality of the consumption condition of the time point issued by the predetermined issuing operation in the consumption provider is ensured by a point sale price which is calculated as the number of the consumed time points for the unit (1 minute) of the “sales promotion time” in the consumption provider, in other words, by the number of the time points (nTP), which corresponds to a value (n) based on the sale price standard of the “sales promotion time”. Thus, the unit of the conversion rate between the time point issued by the consumption condition, i.e., the predetermined issuing operation and the time point consumed by the predetermined consuming operation in the consumption provider is defined as 1:nTP.

For instance, it is assumed that a singing room functions as a consumption provider. First, on the basis of a use fee of 300 Yen for a use time of 1 hour (60 minutes), a sales promotion price is calculated by the sale price standard related to the “sales promotion time”. The sales promotion price of the singing room is 5 Yen per 1 minute (the unit thereof is Yen/min).

Herein, the time point of the present invention is issued based on a physical relative value of “time”, for example, by a unit (min/min) of 1 minute for a “waiting time” of 1 minute. Therefore, a time point sale price based on the sale price standard of the “sales promotion time” of 1 minute in the singing room may be determined as 5TP by the calculation of 5 Yen/min÷1 min/min.

Additionally, for instance, it is assumed that a theater functions as a consumption provider. First, on the basis of an adult fee of 2,400 Yen for a movie's average running time of 120 minutes, the sales promotion price is calculated by the sale price standard related to the “sales promotion time”. The sales promotion price of the theater is 20 Yen per 1 minute (the unit thereof is Yen/min).

Herein, the time point of the present invention is, as described above, issued based on a physical relative value of “time” by a unit (min/min) of 1 minute for 1 minute. Therefore, the time point sale price based on the sale price standard of the “sales promotion time” of 1 minute in the theater may be determined as 20TP by the calculation of 20 Yen/min÷1 min/min.

Also, for example, it is assumed that a massage shop is assumed to be a consumption provider. First, on the basis of a treatment fee of 6,100 Yen for a treatment time of 60 minutes, the sales promotion price is calculated by the sale price standard related to the “sales promotion time”. The sales promotion price of the massage shop is 100 Yen per 1 minute (the unit thereof is Yen/min).

Herein, the time point of the present invention is, as described above, issued based on a physical relative value of “time” by a unit (min/min) of 1 minute for 1 minute. Therefore, the time point sale price based on the sale price standard of the “sales promotion time” of 1 minute in the massage shop may be determined as 100TP by the calculation of 100 Yen/min÷1 min/min,

Also, for example, it is assumed that an aesthetic shop is assumed to be a consumption provider. First, on the basis of a treatment fee of 12,000 Yen for the treatment time of 60 minutes, the sales promotion price is calculated by the sale price standard related to the “sales promotion time”. The sales promotion price of the aesthetic shop is 200 Yen per 1 minute (the unit thereof is Yen/min).

Herein, the time point of the present invention is, as described above, issued based on a physical relative value of “time” by a unit (min/min) of 1 minute for 1 minute. Therefore, the sale price of the time point based on the sale price standard of the “sales promotion time” of 1 minute in the aesthetic shop may be determined as 200TP by the calculation of 200 Yen/min÷1 min/min.

Here, there are many repetitive customers in beauty parlors, aesthetic shops, etc., in some areas. Therefore, for example, in accordance with the embodiment of the present invention, the beauty parlor functions as the issuer of the time point and the aesthetic shop functions as the consumption provider of the time point, so that satisfactions of the goods and services of each store can be easily complemented with each other.

Specifically, the treatment time in the beauty parlor is generally varied by the contents of the treatment and by how much the customers are crowded. Therefore, the treatment time cannot be precisely determined. As a result, the customers often have the “waiting time”.

Since the “waiting time” is generally unpleasant to the customers, the beauty parlor, etc., pay for environmental improvement (luxury sofa, beverages, etc.) in order to reduce the unpleasant feeling. However, according to the embodiment of the present invention, for example, the beauty parlor provides (issues) the time point to the customer (user) on the basis of the “waiting time”, and then the given (issued) time point is used for the “sales promotion time” of the aesthetic shop by the customer (user), so that the “unpleasant time” can be substituted by “pleasant time”. Therefore, an ideal affiliation can be easily established without paying a cost.

In this case, first, the predetermined issuing operation by the user will be described. For example, when the customer (user) possesses the above-described client device and visits a beauty parlor having the above-described location notifying device installed therein, the client device not only detects a Bluetooth-standardized radio wave transmitted by the location notifying device but also acquires identification information of the location notifying device. Then, the identification information of the location notifying device and the identification information of the client device are transmitted from the client device to the time management system of the point management center through the Internet, and also the time measurement begins. When the user leaves the beauty parlor, the client device prevents the Bluetooth-standardized radio wave transmitted by the location notifying device from being detected. Also, the identification information of the location notifying device, the identification information of the client device, and the number of the issued time points, which is calculated based on both the time measured from when the user visits the beauty parlor to when the user leaves the beauty parlor and the predetermined issuing condition are transmitted from the client device to the time management system of the point management center through the Internet. In the time management system, the transmitted identification information of the location notifying device, the transmitted identification information of the client device, and the number of the issued time points are given to the user (are recorded in the point management database).

Additionally, the number of the issued time points, which is calculated based on both the measured time and the predetermined issuing condition in the client device, can be also calculated in the time management system by transmitting the measured time from the client device to the time management system of the point management center on the basis of both the transmitted measured time and the predetermined issuing condition.

Also, the above-described time point issuing condition is set such that the time point is issued based on the “time” from when the client device of the user detects the location notifying device of the beauty parlor (enters the beauty parlor) to when the client device does not detect (leaves the beauty parlor), that is to say, a “staying time” of the user at the beauty parlor. However, the substantive “waiting time” can be simply measured, for example, by installing the location notifying device in a waiting corner or by determining a normal “treatment time” of the beauty parlor and then subtracting the normal “treatment time” from the “staying time”, or the like.

Next, a method in which the customer (user) uses the time point given (issued) based on the “waiting time” in the beauty parlor will be described. For example, according to a predetermined registration operation related to a later-mentioned ┌guide to the use of affiliated store┘, when the above-described aesthetic shop as a consumption provider which accepts the predetermined consuming operation of the user registers basic information such as shop information, etc., or advertising information for notifying sales promotion planning (providing information of the “sales promotion time”, etc.) in an affiliated store guide database of the point management center, the registered shop information or advertising information is reflected in the ┌guide to the use of affiliated store┘. Since the ┌guide to the use of affiliated store┘ is displayed on the user's client device by the dedicated application, the user comes to be aware of the sales promotion planning of the aesthetic shop as a place where the user uses (consumes) his/her own time point.

Then, when the user goes toward the aesthetic shop and executes the dedicated application of the client device, the location notifying device installed in the aesthetic shop is detected by the client device, and the “sales promotion time” at the time of being able to use (consume) in the aesthetic shop is displayed on the client device. Also, by the predetermined consuming operation by the user, for example, by the clicking of a “use button” of the “sales promotion time”, approval information which uses the “sales promotion time” is transmitted from the client device to the time management system of the point management center, and the number of the time points required to use (consume) the “sales promotion time” based on the transmitted “approval information” is subtracted by the time management system. Also, the subtraction result, for example, as a ticket information including a known QR code or a message related to the use for the sales promotion, may be displayed on one or both of a client device (a portable terminal, a PC, etc.) of the aesthetic shop and the user's client device.

Furthermore, with regard to the establishment of the above-described sale price standard related to the “sales promotion time”, for example, a discount is provided to consumers over the age of 60 in a theater, etc., or a discount is provided to female customers in a massage shop, etc. Therefore, changes according to the user's attribute, etc., may be added to the sale price standard.

As described above, the first embodiment of the present invention features that the sales promotion point in a unit of time is a time point which is issued or consumed by measuring a predetermined elapsed period of time of the user at a particular place. Here, the issuance or consumption of the time point is not limited to a particular place related to the provision of the above-described facilities-based service or treatment-based service. The issuance or consumption of the time point is performed, for example, by a particular operation provided by net-based service providers, in other words, by watching net games, music, videos, e-books, etc. A second embodiment of the present invention features that the sales promotion point in a unit of time is a time point which is issued or consumed by measuring a predetermined time related to a particular operation of the user.

Additionally herein, only an outline to add the net-based service provider to the above consumption provider will be described.

In general, since the net-based service providers have already determined the development cost of a game or delivery cost of music/video, they gain a higher profit by the customers' more use of their services. Therefore, their sales promotion activities are very active.

For instance, the game service provider advertises a new game through mass media, distributes posters, etc., extensively or pay a lot of cost in order to appeals the new game to more consumers in the sales promotion of the new game. Through the adoption of the ┌method for distributing the sales promotion point in a unit of time and a distribution management system┘ in accordance with the embodiment of the present invention, the game service provider as the time point issuer or the time point consumption provider comes to be able to issue the time point in accordance with a certain playing time to the user who is playing an existing game or to allow the user possessing the time points to play a new game for a certain period of time by means of a certain amounts of the time points. As a result, the sales promotion cost is significantly reduced.

In this case, the issuance of the time point based on the playing time of the game can be made, for example, by accessing the time management system of the point distribution center and a known game system operated by the game service provider in the present invention through the Internet.

Specifically, the game service provider adds, for example, a later-mentioned and known Web-application programming interface (API), which is released by the point management center and is dedicated to the management of the point, to a game application which is provided through the Internet to the client device, such as a smartphone (mobile phone), PC, etc., of the user participating in the game, so that it may be configured such that game operation information based on the user's game application is transmitted to the time management system of the point management center. Therefore, for instance, in the time management system, not only the time point information including information on user's attribute or information on the balance of the time point is extracted from a user database and the point management database on the basis of the transmitted game operation information of the user, but also the required number of the time points with respect to the sale price standard of the “sales promotion time” preset by the game service provider, in other words, a game participation time point sale price is calculated and the both the time point information and the game participation time point sale price are transmitted to the game system and the client device of the user. The notified time point information and the game participation time point sale price are displayed on the client device. For example, when approval information representing the game participation is transmitted from the client device to the time management system by clicking a “game participation button”, the time management system subtracts the number of the time points, which corresponds to the game participation time point sale price based on the transmitted approval information. Also, when information on the subtraction result is transmitted to the game system, the game system may allow the client device to participate in the game for as long as the “sales promotion time” on the basis of the transmitted subtraction result information.

Also, for example, a music/video distribution service provider advertises a new music or a new video (movie, etc.) through mass media, distributes posters, etc., extensively or pay a lot of cost in order to appeals the new music or new video to more consumers in the sales promotion of the new music or new video. Through the adoption of the ┌method for distributing the sales promotion point in a unit of time and a distribution management system┘ in accordance with the embodiment of the present invention, the music/video distribution service provider as the issuer or the consumption provider comes to be able to issue the time point in accordance with a certain viewing time period to the user who is viewing an existing music or video or to allow the user possessing the time points to view a new music or a new video for a certain period of time by means of a certain amounts of the time points. As a result, the sales promotion cost is significantly reduced.

In this case, the issuance of the time point based on the viewing time of the music or video can be made, for example, by accessing the time management system of the point distribution center and a known music/video distribution system operated by the music/video distribution service provider in the present invention through the Internet.

In addition, “iTune” of Apple Inc. is famous for the known music/video distribution system. Also, the distribution system distributes known e-books, etc., as well as music or video. A table terminal “Kindle” of Amazon Inc. is known as a user terminal of the e-book.

Specifically, the music/video distribution service provider adds, for example, as described above, the Web-application programming interface (API), which is released by the point management center and is dedicated to the management of the point, to a music/video distribution application which is provided through the Internet to the client device, such as a smartphone (mobile phone), PC, etc., of the user viewing the music or video, so that it may be configured such that view operation information based on the user's music/video distribution is transmitted to the time management system of the point management center. Therefore, for instance, in the time management system, not only the time point information including information on user's attribute or information on the balance of the time point is extracted from a user database and the point management database on the basis of the transmitted view operation information of the user, but also the required number of the time points with respect to the sale price standard of the “sales promotion time” preset by the music/video distribution service provider, in other words, a music/video viewing time point sale price is calculated and the both the time point information and the music/video viewing time point sale price are transmitted to a music/video delivery system and the client device of the user. The notified time point information and the music/video viewing time point sale price are displayed on the client device. For example, when approval information representing view start is transmitted from the client device to the time management system by clicking a “view start button”, the time management system subtracts the number of the time points, which corresponds to the music/video viewing time point sale price based on the transmitted approval information. Also, when information on the subtraction result is transmitted to the music/video distribution system, the music/video distribution system may allow the client device to view the music or video for as long as the “sales promotion time” on the basis of the transmitted subtraction result information.

According to the configuration of the present invention, in shopping, using services or all procedures at a member store (corresponding to general stores or public institutions such as a bank, a public office, etc.), the user collects the provided “waiting time” (“unpleasant time”) other than a time period required by the original purpose as the time point, and then is able to convert (consume) the “waiting time” into the “sales promotion time” (“pleasant time”) provided by the member store (corresponding to facilities-based service providers, treatment-based service providers, or net-based service providers). Also, the member store (the issuing hub of the time point) meets goods or services which cannot be provided by itself and the affiliated store (the consuming hub of the time point) obtains sales promotion opportunities without paying a cost, so that a time point distribution system for sales promotion can be implemented, which mutually complements the satisfaction and the obtainment through the time point, and ensures customer's high satisfaction at a low cost.

### Embodiment 1

Hereinafter, an optimal embodiment of the present invention will be described in detail with reference to the drawings.

The first embodiment of the present invention features that the sales promotion point in a unit of time is a time point which is issued or consumed by measuring a predetermined elapsed period of time of the user at a particular place.

In the first embodiment of the present invention, when the user goes to a member store for the purpose of shopping, using services, all procedures, etc., the user's client device (a mobile terminal such as a smartphone, etc., in which an application on the issuing operation and the consuming operation of the time point in a unit of time has been installed) detects, for example, “time” from when the location notifying device installed in the member store is detected to when the location notifying device is not detected. The time point based on the measured “time” can be obtained and collected by the user's client device. Then, the user may convert the obtained and collected time points into, for example, “time” for receiving the sales promotion service provided by the facilities-based, treatment-based, net-based affiliated stores.

Herein, as an important feature of the embodiment of the present invention, the issuing condition for issuing the time point on the basis of the measured “time” in the affiliated store and the consumption condition for exchanging the “time” for receiving the sales promotion service in the affiliated store with the time point can be calculated by the time management system.

That is to say, in the member store, regarding the number of the time points which are issued according to the time of the measurement target, for example, a “congestion waiting time” from when a customer visits the store to when purchase of goods or receipt of service begins, a “providing waiting time” from when the customer orders goods or services to when the goods or services are provided, or an “excess waiting time” obtained by subtracting a commonly required time related to the sales of goods or provision of the service in the store from the staying time from when the customer visits the store to when the customer leaves the store, an example is taken in which a priority of the improvement of the user's “waiting time”, i.e., a measurement target in the member store may be calculated by a relative ratio of “congestion”:“provision”:“excess”=1:3:2. Also, in the affiliated store, regarding the number of the time points which accept the consumption in accordance with the time of the sales promotion target, for example, a “test sales promotion time” related to the induction of the customers to a new service, a “sales strengthening sales promotion time” related to the accomplishment of the goal of the service, or an “opening store sales promotion time” related to a store renewal, etc., an example is taken in which how much an expression of gratitude for user's “visit to the store and use of the store” i.e., a sales promotion target in the affiliated store is reflected may be calculated on the basis of a relative ratio of “test”:“sales strengthening”:“opening store”=2:1:3 and a general sale price of the service, i.e., the sales promotion target.

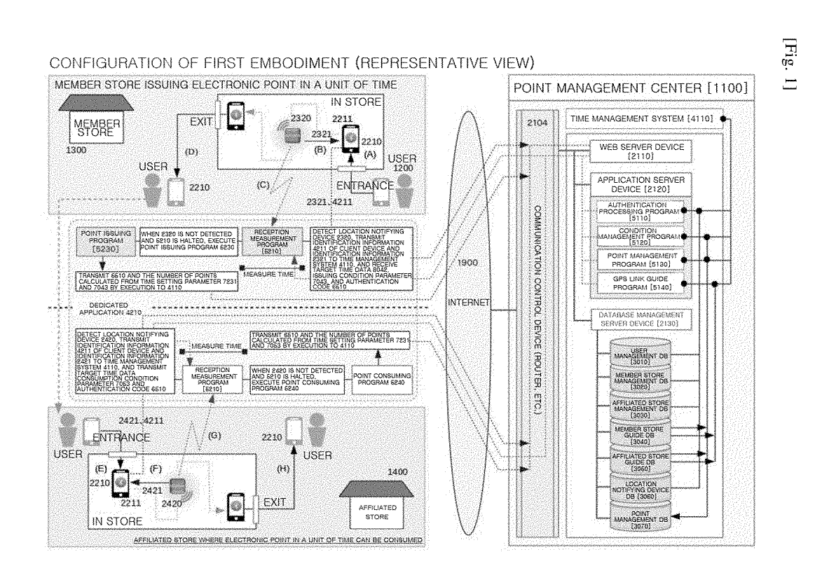

FIG. 1 shows a configuration of the first embodiment of the ┌method for distributing the sales promotion point in a unit of time and a distribution management system┘ which is implemented by the present invention. Flow symbols (A) to (D) shown in FIG. 1 represent the configuration related to the method for issuing the time point in accordance with the present invention. Flow symbols (E) to (H) shown in FIG. 1 represent the configuration of the method for consuming the time point in accordance with the present invention.

First, the configuration of the issuing method according to the embodiment of the present invention will be described in detail by using detail views of the flow symbols (A) to (D) shown in FIG. 1.

Predetermined Issuing Operation by the User

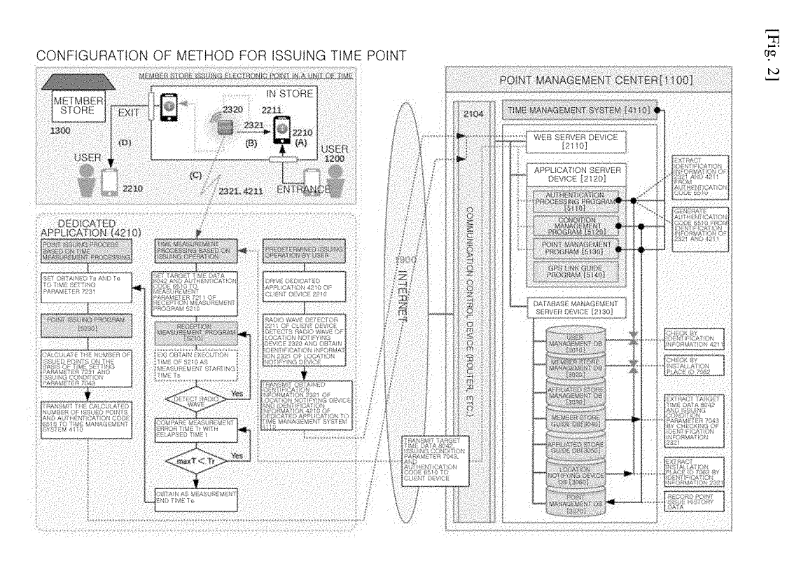

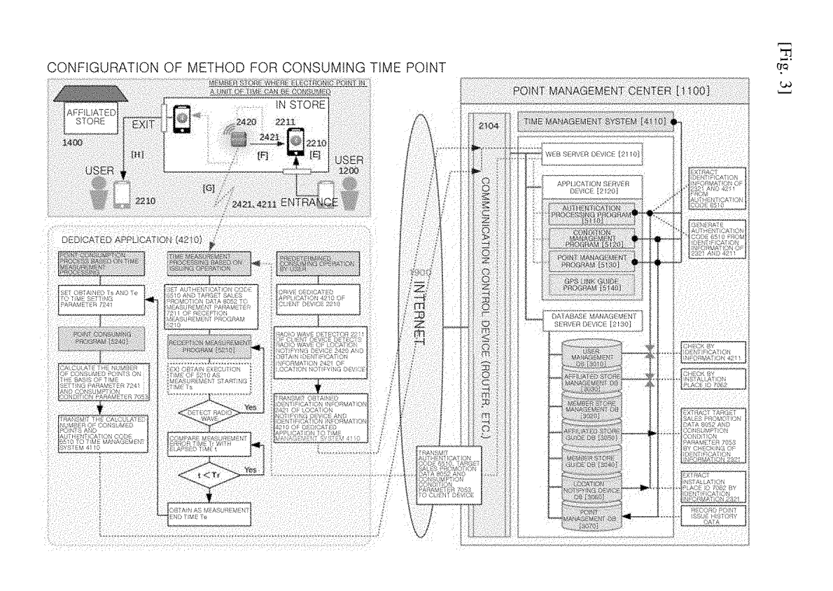

FIG. 2 shows a configuration of the method for issuing the time point. Regarding the predetermined issuing operation by the user, the location notifying device 2320 including a known radio transmitter which is installed in the member store 1300 and transmits a Bluetooth-standardized radio wave is made to be driven. A dedicated application 4210 is composed of a reception measurement program 5210 which measures time while monitoring the radio wave reception state of a radio wave detector 2211, and a point issuing program 5230 for managing the issuance of the time point or a point consuming program 5240 for managing the consumption of the time point (see FIG. 3). The client device 2210 is a mobile terminal such as a smartphone (mobile phone), a tablet PC, etc., which includes the known radio wave detector 2211 detecting the Bluetooth-standardized radio wave. When the user 1200 possessing the client device 2210 which has the dedicated application 4210 installed therein drives the dedicated application 4210 and visits the member store 1300, the Bluetooth-standardized radio wave transmitted from the location notifying device 2320 is detected by the radio wave detector 2211 included in the client device 2210. The detected identification information 2321 of the location notifying device 2320 is obtained by the dedicated application 4210, and the obtained identification information 2321 and identification information 4211 of the dedicated application 4210 are transmitted to the time management system 4110 of the point management center 1100 through Internet 1900 by the dedicated application 4210.

Additionally, each of the programs constituting the dedicated application 4210 can be developed by program languages such as a known HTML, JavaScript, PHP, Perl, Java, C, C++ or the like.

Also, the identification information 4211 of the dedicated application 4210 is specific information for specifying the user who uses the dedicated application 4210. The identification information 4211 is generated as described below on the basis of a known UDID or IMEI, a telephone number, or the like.

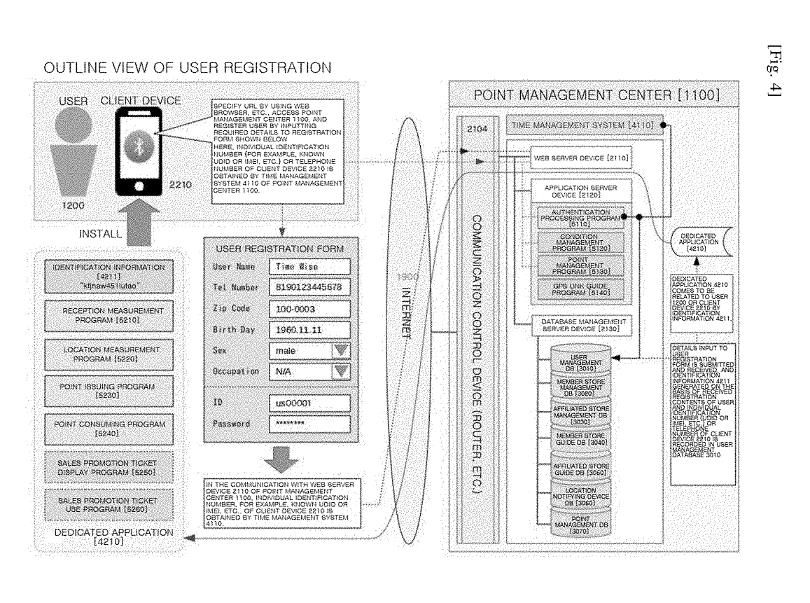

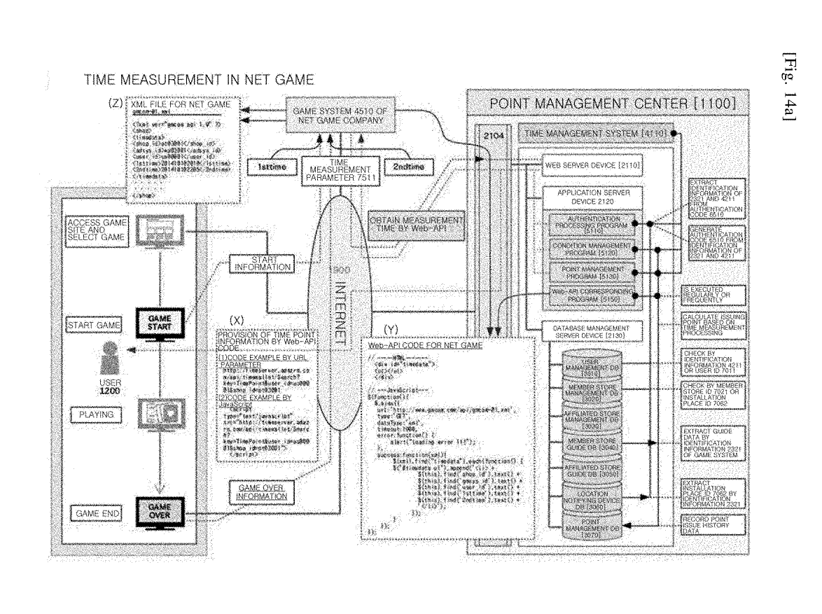

As shown in FIG. 4, first, when the user accesses the time management system 4110 of the point management center 1100 through the Internet by a known Web browser, etc., included in the client device such as a smartphone (mobile phone), a tablet PC, etc., owned by the user, an authentication processing program 5110 constituting the time management system 4110 is executed. Through the execution of the authentication processing program 5110, the client device of the user is provided with a user registration form. With regard to this, when the user submits (inputs) data by inputting or selecting user's required details, user basic data 7013 such as a telephone number, individual identification number, etc., and user attribute data 7014 such as user's name, postal code, gender, age, etc., which are shown in FIG. 15, for example, are obtained through the submission by the authentication processing program 5110.

Herein, for example, the above identification information 4211 comprised of the telephone number and the individual identification number of the obtained user basic data 7013 is generated by the authentication processing program 5110. Also, for example, not only the generated identification information 4211 is written in an identification information record code of the dedicated application 4210, but also the identification information 4211 and the obtained user basic data or user attribute data 7014 are recorded in a user management database 3010 in accordance with a record-layout of the user management database shown in FIG. 15. Furthermore, the dedicated application 4210 is downloaded to the user's client device through the Internet 1900.

By doing this, the identification information 4211 written in the dedicated application 4210 installed in the user's client device 2210 comes to be related to the user basic data 7013 recorded in the user management database 3010.

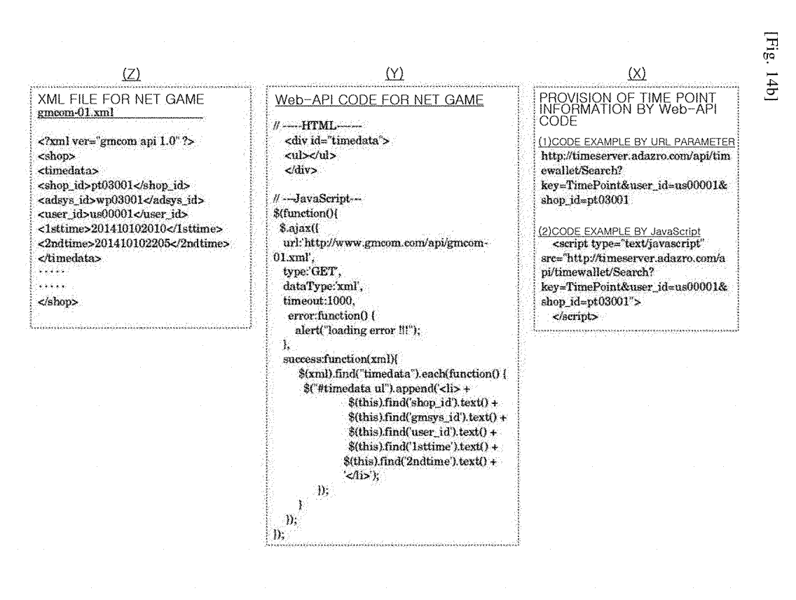

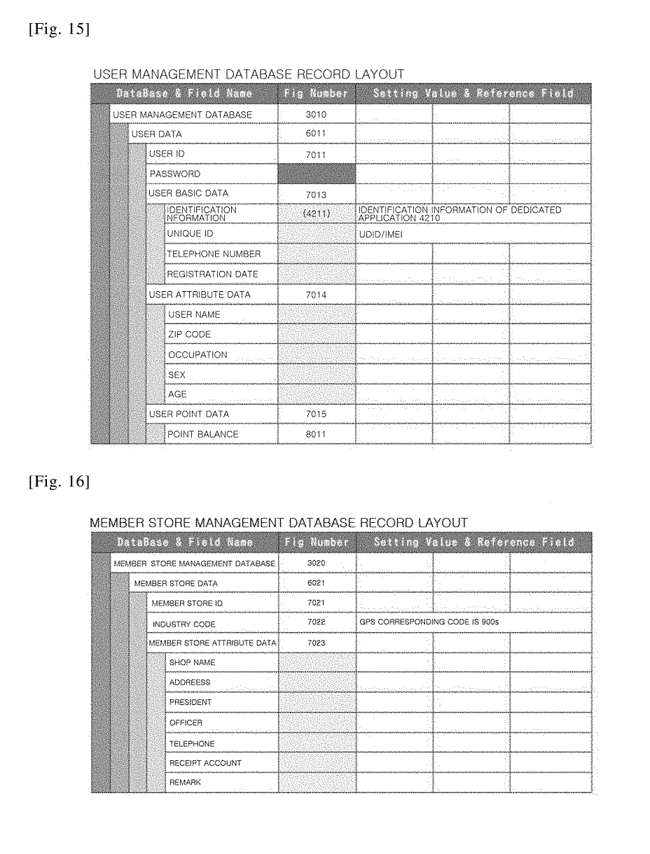

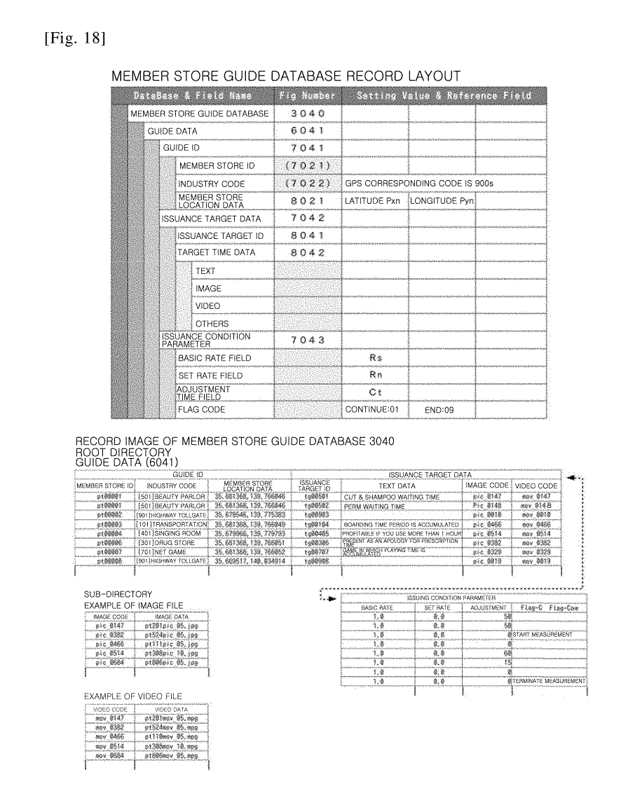

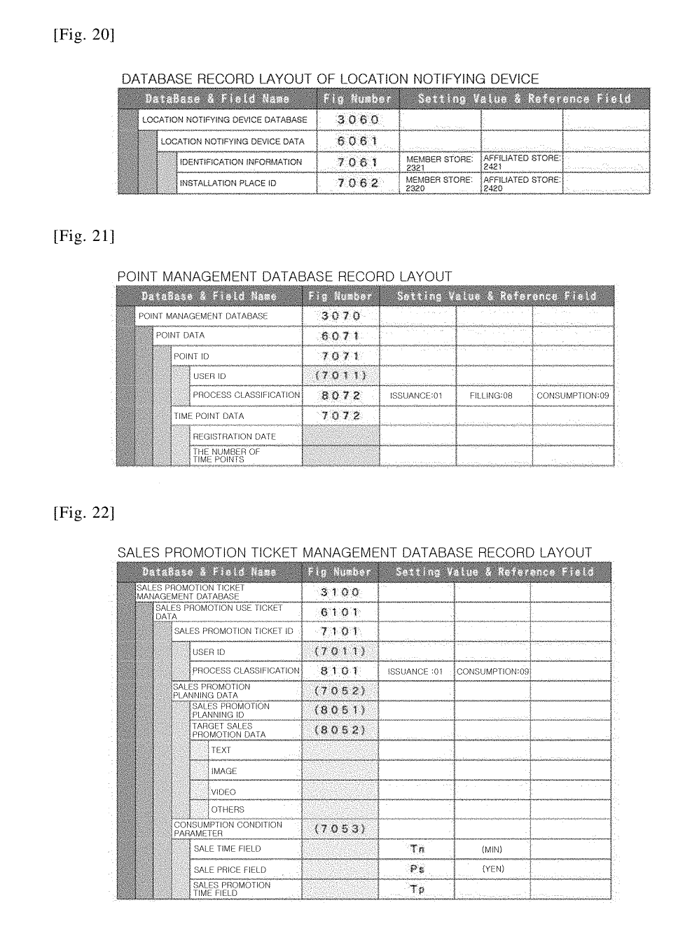

Here, as shown in FIG. 2, the time management system 4110 is a server system which is composed of a communication control device 2104, a Web server device 2110, an application server device 2120, and a database management server device 2130. In the time management system 4110, when the identification information 2321 of the location notifying device 2320 and the identification information 4211 of the dedicated application 4210 are received, the authentication processing program 5110 of the application server device 2120, which constitutes the time management system 4110, is executed. Through this execution, the location notifying device is checked in a predetermined manner, that is to say, it is checked by using the database management server device 2130 of the time management system 4110 whether the received identification information 2321 of the location notifying device 2320 is registered or not in a location notifying device database 3060 shown in FIG. 20. For example, an installation place ID 7062 corresponding to a member store ID 7021 (see FIG. 16) of the member store 1300 in which the location notifying device 2320 of the identification information 2321 has been installed is detected from the location notifying device database 3060 by using the identification information 2321 as a search key, and also, the user is checked in a predetermined manner, that is to say, it is checked by using the database management server device 2130 whether the received identification information 4211 of the dedicated application 4210 is registered or not in the user management database 3010 shown in FIG. 15. For example, a user ID 7011 or user attribute data 7014, etc., of the user 1200 is detected from the user management database 3010 by using the identification information 4211 as a search key, so that an authentication code 6510 consisting of the identification information 4211 and identification information 2321 is generated. Also, the installation place ID 7062 corresponding to the member store ID 7021 of the member store 1300 detected by checking the identification information 2321 of the location notifying device 2320, that is to say, by checking the location notifying device in a predetermined manner is used as a search key by a condition management program 5120 of the application server device 2120. Then, a guide data 6041 composed of an issuance target data 7042 set by the member store 1300 and of an issuing condition parameter 7043 is extracted from a member store guide database 3040 to be described later in FIG. 18. A target time data 8042 set in the issuance target data 7042, the issuing condition parameter 7043, and the formed authentication code 6510 are transmitted from the time management system 4110 to the client device 2210 through the Internet 1900.

Besides, the issuing condition parameter 7043 will be described later.

### Time Measurement Processing on the Issuing Operation

Regarding the time measurement processing based on the aforementioned [predetermined issuing operation by the user], as shown in FIG. 2, in the client device 2210, when the target time data 8042, the issuing condition parameter 7043, and the authentication code 6510 are received, the target time data 8042 and the authentication code 6510 are first set to a measurement parameter of the reception measurement program 5210 constituting the dedicated application 4210 by the dedicated application 4210, so that the reception measurement program 5210 is executed. Through this execution, as long as the Bluetooth-standardized radio wave transmitted from the location notifying device 2320 is detected by the radio wave detector 2211 included in the client device 2210, not only the time is measured, but also in accordance with the setting of a measurement starting time of the target time data 8042, for example, in accordance with the setting of an execution time of the reception measurement program 5210 to the measurement starting time, the execution time is obtained as the measurement starting time Ts by the dedicated application 4210.

Herein, as shown in FIG. 2, the measurement parameter of the reception measurement program 5210 includes a key value allowing the reception measurement program 5210 to establish and maintain communication between the client device 2210 and the location notifying device 2320, which correspond respectively to the identification information 4211 and the identification information 2321, i.e., the components of the authentication code 6510 set to the measurement parameter. The key value may correspond to a known pairing key in a Bluetooth communication or a known WEP key in a WiFi communication, etc.

Next, as shown in FIG. 2, the user 1200 possessing the client device 2210 leaves the member store 1300, and the radio wave detector 2211 included in the client device 2210 does not detect the Bluetooth-standardized radio wave transmitted from the location notifying device 2320 for more than an error setting time Er, and the execution of the reception measurement program 5210 is ended. Then, in this case, in accordance with the setting of a measurement end time of the target time data 8042, for example, in accordance with the setting of an execution end time of the reception measurement program 5210 to the measurement end time, the time at which the execution of the reception measurement program 5210 is ended is obtained as the measurement end time Te.

In addition, the error setting time Er is used to judge whether or not the user leaves the member store or affiliated store. The radio wave which is detected by the known radio wave detector included in the client device is interfered by the structure, shape, etc., of a building in which a transmitter transmitting the radio wave is installed. Therefore, the location notifying device is installed in the member store or affiliated store such that, for example, the location notifying device is installed near the entrance of the member store or affiliated store as a measurement starting place and an elapsed time pT from when the client device is moved at a normal walking speed (4 Km/h) from a plurality of locations at a distance that the radio wave of the location notifying device is not detected by the client device to when the radio wave of the location notifying device is detected by the client device is measured a plurality of number of times, or such that the location notifying device is installed near the exit of the member store or affiliated store as a measurement end place and an elapsed time pT from when the client device is moved at a normal walking speed (4 Km/h) from a plurality of locations at a distance that the radio wave of the location notifying device is detected by the client device to when the radio wave of the location notifying device is not detected by the client device is measured a plurality of number of times. As a result, the error setting time Er is set, for example, to an average value avrT or a maximum value maxT of the elapsed time pT.

### Calculation of Issuing Point Based on the Time Measurement Processing

Continuing with the aforementioned [time measurement processing on the issuing operation], as shown in FIG. 2, the measurement starting time Ts and the measurement end time Te obtained by the dedicated application 4210 in the execution of the reception measurement program 5210 are set to a time setting parameter 7231 of the point issuing program 5230 constituting the dedicated application 4210 by the dedicated application 4210. Also, the point issuing program 5230 is executed and the number of the issued time points based on the time setting parameter 7231 and the issuing condition parameter 7043 is calculated by the execution of the point issuing program 5230.

Here, the time setting parameter 7231 is composed of a starting time field to which the measurement starting time Ts is assigned, an end time field to which the measurement end time Te is assigned, an error time field to which the error setting time Er is assigned, etc. Also, as shown in FIG. 18, the issuing condition parameter 7043 is composed of a basic rate field which is determined by the point management center 1100, an adjustment time field, or a set rate field which is arbitrarily set by the member store 1300. For example, 1 as a basic rate Rs indicating that the time point of 1TP (TP is a unit of the time point) is issued for a unit time of 1 minute of an actually measured time St is assigned to the basic rate field. A set rate Rn in a case where the member store 1300 independently issues the time point is assigned to the set rate field. When the time point is, for example, provided for a time period excessing the time required for providing a normal service or treatment, etc., the required time, as an adjustment time Ct, subtracted from the actually measured time St is assigned to the adjustment time field.

According to the above-description, for example, let us assume the actually measured time St is determined by an expression {St=(Te−Ts−Er)} based on the measurement starting time Ts, measurement end time Te, and error setting time Er. In this case, the number Ep of the issued time points, which is calculated by the point issuing program 5230, is calculated by an expression {Ep=(St−Ct)×Rs} on the basis of the basic rate Rs assigned to the basic rate field of the time setting parameter 7231 and the issuing condition parameter 7043 and of the adjustment time Ct assigned to the adjustment time field.

### Time Point Issue History Data Management Process

As shown in FIG. 2, in the client device 2210, when the execution of the point issuing program 5230 constituting the dedicated application 4210 is ended, the authentication code 6510 and the calculated number of the issued time points are transmitted to the time management system 4110 of the point management center 1100 through the Internet 1900 by the dedicated application 4210. When the time management system 4110 receives them, the authentication processing program 5110 of the time management system 4110. Through the execution, the authentication code is checked in a predetermined manner, that is to say, it is checked by using the database management server device 2130 of the time management system 4110 whether the received identification information 2321 of the location notifying device 2320 and the received identification information 4211 of the dedicated application 4210, which are the components of the authentication code 6510, are registered or not in the location notifying device database 3060 shown in FIG. 20 and in the user management database 3010 shown in FIG. 15, respectively. For example, the installation place ID 7062 corresponding to a member store ID 7021 (see FIG. 16) of the member store 1300 in which the location notifying device 2320 of the identification information 2321 has been installed is detected from the location notifying device database 3060 by using the identification information 2321 as a search key. Also, the user ID 7011 or user attribute data 7014, etc., of the user 1200 is detected from the user management database 3010 by using the identification information 4211 as a search key, so that a point management program 5130 of the application server device 2120, which constitutes the time management system 4110, is executed. Through the execution of the point management program 5130, the checked identification information 2321 of the location notifying device 2320, the checked identification information 4211 of the dedicated application 4210, and the history data which consists of the received number of the issued time points and corresponds to the “issuance” of the time point are recorded in the corresponding point management database 3070 by using the database management server device 2130 in accordance with a record-layout of the corresponding point management database shown in FIG. 21.

As above, the sales promotion point in a unit of time, i.e., the time point is provided in accordance with the “waiting time” of the customer in the member store, for example, the “congestion waiting time” from when the customer visits the store to when purchase of goods or receipt of service begins, the “providing waiting time” from when the customer orders goods or services to when the goods or services are provided, or the “excess waiting time” obtained by subtracting a commonly required time related to the sale of goods or provision of the service in the store from the staying time from when the customer visits the store to when the customer leaves the store, or the like.

Needless to say, such a service by the member store must be efficiently notified to the user. Therefore, in the described structure of the present invention, a structure for providing (indicating) an ┌member store guide┘ is added to the client device of the user.

### ┌Member Store Guide┘ Registration Process

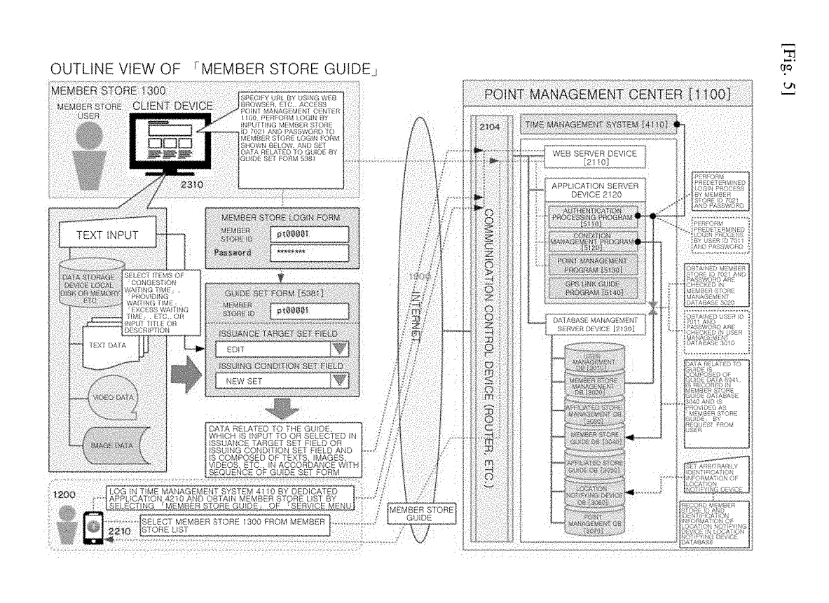

Specifically, as shown in the outline view of FIG. 5, the user of the member store 1300 accesses a Web page which is released by the Web server device 2110 of the point management center 1100 and is related to the ┌member store guide┘ through the Internet 1900 by means of the client device 2310 such as a PC including a Web browser, a member store login form is displayed on the Web browser and a member store ID and a password are input and submitted (data input) to the member store login form. Then, not only the submitted member store ID and password are obtained by the time management system 4110 of the point management center 1100, but also the authentication processing program 5110 of the application server device 2120, which constitutes the time management system 4110, is executed. As a result of the execution, a predetermined login process is performed.

In the process of the predetermined login, when it is checked whether the obtained member store ID and password are registered in a member store management database 3020 (FIG. 16) of the point management center 1100 and when the member store ID 7021 corresponding to the obtained member store ID is extracted, the login is completed, and then a guide set form 5381 is provided (indicated) in the Web browser of the client device 2310. Through the following predetermined guide set operation for the guide set form 5381, the guide data 6041 of the member store 1300 is formed 11 and is recorded in the member store guide database 3040 shown in FIG. 18 of the point management center 1100.

The predetermined guide set operation is performed as follows. When the user of the member store 1300 sets in accordance with the guide set form 5381 a guide for the time point which is issued to the user 1200, the set guide is composed of the guide data 6041 (FIG. 18) and is recorded in the member store guide database 3040. First, regarding an issuance target set field of the guide set form 5381, for example, an item related to the above-described “congestion waiting time”, “providing waiting time”, “excess waiting time”, etc., is selected as a target time at which the time point is issued to the user 1200. Not only a title, description, or the like is input in the form of a text, but also images or videos for guiding which are stored in a local disk or memory, etc., provided to the client device 2310 are selected. Also, in an issuing condition set field of the guide set form 5381, with regard to the number of the time points which are issued in accordance with the target time, that is to say, the number of the time points which are issued for a unit time of 1 minute of the measured time, which has been mentioned in the above-described “calculation of issuing point based on the time measurement processing”, the basic rate Rs is selected or the set rate Rn is input when the member store 1300 independently issues the time point. Furthermore, for example, in a case where the time point is provided for a time period excessing the required time for a normal service or treatment, etc., when the adjustment time Ct of the required time subtracted from the actually measured time St is input and submitted (data input), not only the data related to the guide of the member store 1300, which is input to or selected in the issuance target set field or in the issuing condition set field of the guide set form 5381 and is composed of texts, images, videos, etc., is obtained in the time management system 4110, but also the condition management program 5120 of the application server device 2120, which constitutes the time management system 4110, is executed. Through the execution of the condition management program 5120, in accordance with a record-layout of the member store guide database shown in FIG. 18, the data obtained by the submission is composed of the guide data 6041 which is based on the issuance target data 7042 which is composed of texts, images, videos, etc., and includes an issuance target ID 8041, on the issuing condition parameter 7043 which is composed of the basic rate, the set rate, the adjustment time, a flag code, etc., for the time point which is issued according to the target time, and on a guide ID 7041 composed of the member store ID 7021 and an industry code 7022 of the member store 1300. Also, through use of the database management server device 2130, the guide data 6041 is recorded in the member store guide database 3040, and then the registration of the ┌member store guide┘ is completed.

In addition, the identification information of the location notifying device which is installed on the member store 1300 in which the guide data 6041 has been registered by the above is arbitrarily set by the point management center 1100. The set identification information and the member store ID 7021 of the member store 1300 are recorded as an identification information 7061 and the installation place ID 7062 in the location notifying device database 3060 in accordance with a record-layout of the location notifying device database shown in FIG. 20.

### ┌Member Store Guide┘ providing Method

As shown in FIG. 5, the ┌member store guide┘ registered as above is provided to the user 1200 as follows.

When the user 1200 drives the above-described dedicated application 4210 of the client device 2210 and the client device 2210 accesses the time management system 4110 of the point management center 1100 through the Internet 1900, a user login form is displayed on the client device 2210. Then, when the user ID 7011 and password are input and submitted (data input) to the user login form, the submitted user ID 7011 and password are obtained by the time management system 4110 of the point management center 1100, and a predetermined login process is performed.

In the predetermined login process, when it is checked that the obtained user ID 7011 and password are registered in the user management database 3010 (FIG. 15) of the point management center 1100, the login is completed. Therefore, an initial image including a “service menu” is displayed on a display of the client device 2210.

The “service menu” includes a selection called ┌member store guide┘ which provides a list of the member stores issuing the time point or provides the guide for each member store. First, when the user 1200 selects the ┌member store guide┘, not only the selection information is obtained in the time management system 4110, but also the condition management program 5120 of the application server device 2120, which constitutes the time management system 4110, is executed. Through this execution, the guide ID 7041 and the issuance target data 7042 are extracted for each member store from the member store guide database 3040 shown in FIG. 18. Also, the member store list including the extracted guide ID 7041 and the extracted issuance target data 7042 for each member store is generated. When the generated member store list is transmitted to the client device 2210 through the Internet 1900, the transmitted member store list is not only obtained but also is displayed on the display of the client device 2210 by the dedicated application 4210.

Here, the user 1200 is able to check the descriptions consisting of texts of the issuance target data 7042 included in the transmitted list of the member stores or to check images of the image data. For example, when the user selects his/her favorite member store 1300 from the member store list, not only the guide ID 7041 included in the selection information of the member store 1300 is obtained in the time management system 4110, but also the condition management program 5120 is executed. Through this execution, the guide data 6041 of the member store 1300 is extracted from the member store guide database 3040 on the basis of the obtained guide ID 7041. When the extracted guide data 6041 is transmitted to the client device 2210 through the Internet 1900, the transmitted guide data 6041 of the member store 1300 is obtained by the dedicated application 4210 and is displayed on the display of the client device 2210. Also, the user is provided with the ┌member store guide┘ which relates to the issuing condition of the time point or the store information of the member store 1300, etc., and is composed of texts, images, videos, etc.

As such, by the ┌member store guide┘ registration process and ┌member store guide┘ providing method, the service related to the time point issuance by the member store is efficiently notified to the user.

Next, the configuration of the method for consuming the time point in the present invention will be described in detail by using detail views of the flow symbols (E) to (H) shown in FIG. 1.

### Predetermined Consuming Operation by the User

FIG. 3 shows the configuration of the method for consuming the time point. Regarding the predetermined issuing operation by the user, a location notifying device 2420 including a known radio transmitter which is installed in an affiliated store 1400 and transmits a Bluetooth-standardized radio wave is made to be driven. The dedicated application 4210 is composed of the reception measurement program 5210 which measures time while monitoring the radio wave reception state of the radio wave detector 2211, and the point consuming program 5240 for managing the consumption of the time point or the point issuing program 5230 for managing the issuance of the time point (see FIG. 2). The client device 2210 is a mobile terminal such as a smartphone (mobile phone), a tablet PC, etc., which includes the known radio wave detector 2211 detecting the Bluetooth-standardized radio wave. When the user 1200 possessing the client device 2210 which has the dedicated application 4210 installed therein drives the dedicated application 4210 and visits the affiliated store 1400, the Bluetooth-standardized radio wave transmitted from the location notifying device 2420 is detected by the radio wave detector 2211 included in the client device 2210. The detected identification information 2421 of the location notifying device 2420 is obtained by the dedicated application 4210, and the obtained identification information 2421 and the identification information 4211 of the dedicated application 4210 are transmitted to the time management system 4110 of the point management center 1100 through the Internet 1900 by the dedicated application 4210.

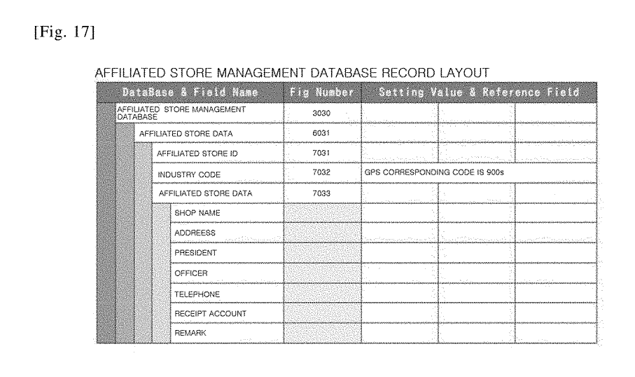

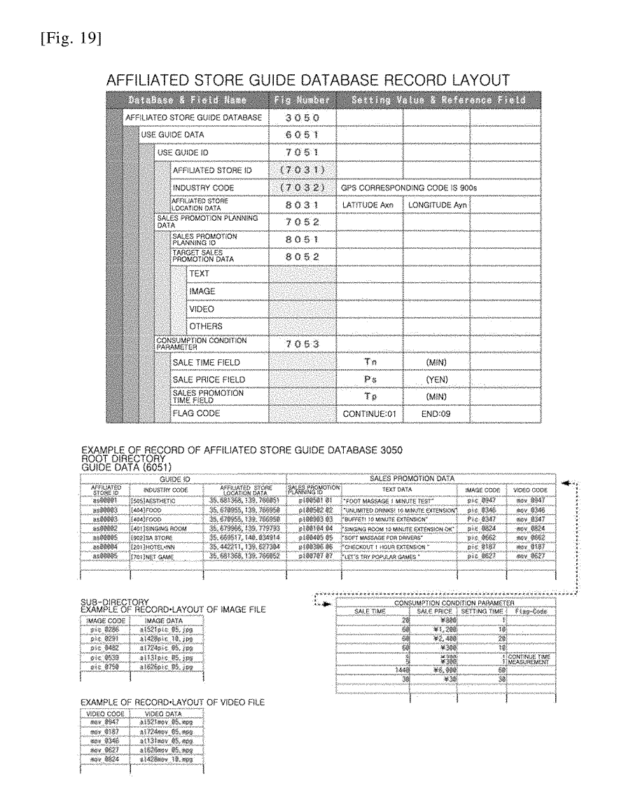

Here, as shown in FIG. 3, in the time management system 4110, when the identification information 2421 of the location notifying device 2420 and the identification information 4211 of the dedicated application 4210 are received, the authentication processing program 5110 of the application server device 2120, which constitutes the time management system 4110, is executed. Through the execution of the authentication processing program 5110, the location notifying device is checked in a predetermined manner, that is to say, it is checked by using the database management server device 2130 of the time management system 4110 whether the received identification information 2421 of the location notifying device 2420 is registered or not in the location notifying device database 3060 shown in FIG. 20. For example, the installation place ID 7062 corresponding to an affiliated store ID 7031 (see FIG. 17) of the affiliated store 1400 in which the location notifying device 2420 of the identification information 2421 has been installed is detected from the location notifying device database 3060 by using the identification information 2421 as a search key, and also, the user is checked in a predetermined manner, that is to say, it is checked by using the database management server device 2130 whether the received identification information 4211 of the dedicated application 4210 is registered or not in the user management database 3010 shown in FIG. 15. For example, a user ID 7011 or user attribute data 7014, etc., of the user 1200 is detected from the user management database 3010 by using the identification information 4211 as a search key, so that an authentication code 6510 consisting of the identification information 4211 and identification information 2421 is formed. Also, the installation place ID 7062 corresponding to the affiliated store ID 7031 of the affiliated store 1400 detected by checking the identification information 2421 of the location notifying device 2420, that is to say, by checking the location notifying device in a predetermined manner is used as a search key by a condition management program 5120 of the application server device 2120. Then, a use guide data 6051 composed of a sales promotion planning data 7052 set by the affiliated store 1400 and of a consumption condition parameter 7053 is extracted from an affiliated store guide database 3050 to be described later in FIG. 19. A target sales promotion data 8052 set in the sales promotion planning data 7052, the consumption condition parameter 7053, and the formed authentication code 6510 are transmitted from the time management system 4110 to the client device 2210 through the Internet 1900.

In addition, the consumption condition parameter 7053 will be described below.

### Time Measurement Processing on the Consuming Operation

Regarding the time measurement processing based on the aforementioned [predetermined consuming operation by the user], as shown in FIG. 3, in the client device 2210, when the target sales promotion data 8052, the consumption condition parameter 7053, and the authentication code 6510 are received, the target sales promotion data 8052 and the authentication code 6510 are set to a measurement parameter of the reception measurement program 5210 constituting the dedicated application 4210 by the dedicated application 4210, so that the reception measurement program 5210 is executed. Through this execution, as long as the Bluetooth-standardized radio wave transmitted from the location notifying device 2420 is detected by the radio wave detector 2211 included in the client device 2210, not only the time is measured, but also in accordance with the setting of a measurement starting time of the target sales promotion data 8052, for example, in accordance with the setting of an execution time of the reception measurement program 5210 to the measurement starting time, the execution time is obtained as the measurement starting time Ts by the dedicated application 4210.

In addition, the measurement parameter is the same as that described above.

Next, as shown in FIG. 3, the user 1200 possessing the client device 2210 leaves the affiliated store 1400, and the radio wave detector 2211 included in the client device 2210 does not detect the Bluetooth-standardized radio wave transmitted from the location notifying device 2420 for more than the error setting time Er, and the execution of the reception measurement program 5210 is ended. Then, in this case, in accordance with the setting of a measurement end time of the target sales promotion data 8052, for example, in accordance with the setting of an execution end time of the reception measurement program 5210 to the measurement end time, the time at which the execution of the reception measurement program 5210 is ended is obtained as the measurement end time Te.

### Calculation of Consumption Point Based on the Time Measurement Processing

Continuing with the aforementioned [time measurement processing on the consuming operation], as shown in FIG. 3, the measurement starting time Ts and the measurement end time Te obtained by the dedicated application 4210 in the execution of the reception measurement program 5210 are set to a time setting parameter 7241 of the point consuming program 5240 constituting the dedicated application 4210 by the dedicated application 4210. Also, the point consuming program 5240 is executed and the number of the consumed time points based on the time setting parameter 7241 and the consumption condition parameter 7053 is calculated by the execution of the point consuming program 5240.

Here, the time setting parameter 7241 is composed of the starting time field to which the measurement starting time Ts is assigned, the end time field to which the measurement end time Te is assigned, the error time field to which the error setting time Er is assigned, etc. Also, in accordance with a use guide set form to be described in the later-mentioned ┌guide to the use of affiliated store┘, the consumption condition parameter 7053 is composed of a sale time field, a sale price field, and a sales promotion time field which are arbitrarily set by the affiliated store 1400. For example, a sale time Tn of a normal service sold by the affiliated store 1400 is set in the sale time field, a sale price Ps of the sale time Tn is set in the sale price field, and a sales promotion time Tp that is provided to the user is set in the sales promotion time field by the point sale price (Yen/min) based on the sale time Tn and the sale price Ps.

According to the above-description, for example, let us assume that the actually measured time St is determined by an expression {St=(Te−Ts−Er)} based on the measurement starting time Ts, measurement end time Te, and error setting time Er. In this case, the number Cp of the consumed time points, which is calculated by the point consuming program 5240, is calculated by an expression {Cp=(Ps÷Tn)×Tp} on the basis of the sale time Tn, the sale price Ps, and the sales promotion time Tp which are set in the fields, respectively, of the time setting parameter 7241 and the consumption condition parameter 7053.

### Time Point Consumption History Data Management Process

As shown in FIG. 3, in the client device 2210, when the execution of the point consuming program 5240 constituting the dedicated application 4210 is ended, the authentication code 6510 and the calculated number of the consumed time points are transmitted to the time management system 4110 of the point management center 1100 through the Internet 1900 by the dedicated application 4210. When the time management system 4110 receives them, the authentication processing program 5110 of the time management system 4110. Through the execution, the authentication code is checked in a predetermined manner, that is to say, it is checked by using the database management server device 2130 of the time management system 4110 whether the received identification information 2421 of the location notifying device 2420 and the identification information 4211 of the dedicated application 4210, which are the components of the authentication code 6510, are registered or not in the location notifying device database 3060 shown in FIG. 20 and in the user management database 3010 shown in FIG. 15, respectively. For example, the installation place ID 7062 corresponding to the affiliated store ID 7031 (see FIG. 17) of the affiliated store 1400 in which the location notifying device 2420 of the identification information 2421 has been installed is detected from the location notifying device database 3060 by using the identification information 2421 as a search key. Also, the user ID 7011 or user attribute data 7014, etc., of the user 1200 is detected from the user management database 3010 by using the identification information 4211 as a search key, so that the point management program 5130 of the application server device 2120, which constitutes the time management system 4110, is executed. Through the execution of the point management program 5130, the checked identification information 2421 of the location notifying device 2420, the checked identification information 4211 of the dedicated application 4210, and the history data which consists of the received number of the consumed time points and corresponds to the “consumption” of the time point are recorded in the corresponding point management database 3070 by using the database management server device 2130 in accordance with a record-layout of the corresponding point management database shown in FIG. 21.

As above, in accordance with the “sales promotion time” for the customer in the affiliated store, for example, the “test sales promotion time” related to the induction of the customers to a new service, the “sales strengthening sales promotion time” related to the accomplishment of the goal of the service, or the “opening store sales promotion time” related to a store renewal, etc., it is possible to realize a service in which the time point can be consumed.

Needless to say, such a sales promotion planning by the affiliated store must be efficiently notified to the user. Therefore, in the described structure of the present invention, a structure for providing (indicating) the ┌guide to the use of affiliated store┘ is added to the client device of the user.

### ┌Guide to the Use of Affiliated Store┘ Registration Process

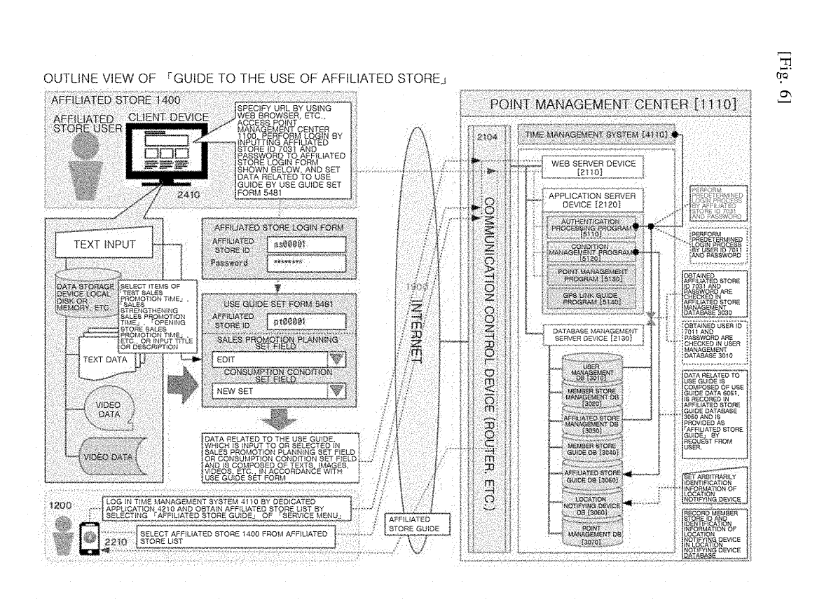

Specifically, as shown in the outline view of FIG. 6, the user of the affiliated store 1400 accesses a Web page which is released by the Web server device 2110 of the point management center 1100 and is related to the ┌guide to the use of affiliated store┘ through the Internet 1900 by means of a client device 2410 such as a PC including a Web browser, an affiliated store login form is displayed on the Web browser and an affiliated store ID and a password are input and submitted (data input) to the affiliated store login form. Then, not only the submitted affiliated store ID and password are obtained by the time management system 4110 of the point management center 1100, but also the authentication processing program 5110 of the application server device 2120, which constitutes the time management system 4110, is executed. As a result of the execution, a predetermined login process is performed.

In the process of the predetermined login, when it is checked whether the obtained affiliated store ID and password are registered in an affiliated store management database 3030 (FIG. 17) of the point management center 1100 and when the affiliated store ID 7031 corresponding to the obtained affiliated store ID is extracted, the login is completed, and then a use guide set form 5481 is provided (indicated) in the Web browser of the client device 2410. Through the following predetermined guide set operation for the use guide set form 5481, the use guide data 6051 of the affiliated store 1400 is formed and is recorded in the affiliated store guide database 3050 shown in FIG. 19 of the point management center 1100.

The predetermined guide set operation is performed as follows. When the user of the affiliated store 1400 sets in accordance with the use guide set form 5481 a use guide for the sales promotion planning in which the user 1200 is able to use (consumes) the time point, the set use guide is comprised of the use guide data 6051 and is recorded in the affiliated store guide database 3050. First, regarding a sales promotion planning set field of the use guide set form 5481, for example, an item related to the above-described “test sales promotion time”, “sales strengthening sales promotion time”, and “opening store sales promotion time”, etc., is selected as a target time at which the user 1200 is able to use (consume) the time point. Not only a title, description, or the like is input in the form of a text, but also images or videos for the use guide, which are stored in a local disk or memory, etc., provided to the client device 2410 are selected. Also, in a consumption condition set field of the use guide set form 5481, with regard to the number of the consumed time points by the sales promotion planning, which has been mentioned in the above-described in the “calculation of consumption point based on the time measurement processing”, the sale time Tn of the normal service that the affiliated store 1400 sells is input, and the sale price Ps of the sale time Tn is input. Furthermore, when the sales promotion time Tp that is provided to the user is input and submitted (data input) by the point sale price (Yen/min) based on the sale time Tn and the sale price Ps, not only the data related to the use guide of the affiliated store 1400, which is input to or selected in the sales promotion planning set field or in the consumption condition set field of the use guide set form 5481 and is composed of texts, images, videos, etc., is obtained in the time management system 4110, but also the condition management program 5120 of the application server device 2120, which constitutes the time management system 4110, is executed. Through the execution of the condition management program 5120, in accordance with a record-layout of the affiliated store guide database shown in FIG. 19, the data obtained by the submission is composed of the use guide data 6051 which is based on the sales promotion planning data 7052 which is composed of texts, images, videos, etc., and includes a sales promotion planning ID 8051, on the consumption condition parameter 7053 composed of the sale time or the sale price of the normal service that the affiliated store 1400 sells, and the flag code for the time measurement, etc., and on a use guide ID 7051 composed of the affiliated store ID 7031 and an industry code 7032 of the affiliated store 1400. Also, through use of the database management server device 2130, the use guide data 6051 is recorded in the affiliated store guide database 3050, and then the registration of the ┌guide to the use of affiliated store┘ is completed.

In addition, the identification information of the location notifying device which is installed on the affiliated store 1400 in which the use guide data 6051 has been registered by the above is arbitrarily set by the point management center 1100. The set identification information and the affiliated store ID 7031 of the affiliated store 1400 are recorded as the identification information 7061 and the installation place ID 7062 in the location notifying device database 3060 in accordance with the record-layout of the location notifying device database shown in FIG. 20.

### ┌Guide to the Use of Affiliated Store┘ providing Method

As shown in FIG. 6, the ┌guide to the use of affiliated store┘ registered as above is provided to the user 1200 as follows.

When the user 1200 drives the above-described dedicated application 4210 of the client device 2210 and the client device 2210 accesses the time management system 4110 of the point management center 1100 through the Internet 1900, the user login form is displayed on the client device 2210. Then, when the user ID 7011 and password are input and submitted (data input) to the user login form, not only the submitted user ID 7011 and password are obtained by the time management system 4110 of the point management center 1100, but also the authentication processing program 5110 of the application server device 2120, which constitutes the time management system 4110, is executed. Through the execution of the authentication processing program 5110, a predetermined login process is performed.

In the predetermined login process, when it is checked that the obtained user ID 7011 and password are registered in the user management database 3010 (FIG. 15) of the point management center 1100, the login is completed. Therefore, an initial image including the “service menu” is displayed on the display of the client device 2210.

The “service menu” includes a selection called ┌guide to the use of affiliated store┘ which provides a list of the affiliated stores in which the time point can be used (consumed) or provides a use guide for each affiliated store. First, when the user 1200 selects the ┌guide to the use of affiliated store┘, not only the selection information is obtained in the time management system 4110, but also the condition management program 5120 of the application server device 2120, which constitutes the time management system 4110, is executed. Through this execution, the use guide ID 7051 and the sales promotion planning data 7052 are extracted for each affiliated store from the affiliated store guide database 3050 shown in FIG. 19. Also, the affiliated store list including the use guide ID 7051 and the sales promotion planning data 7052 for each affiliated store is generated. When the generated affiliated store list is transmitted to the client device 2210 through the Internet 1900, the transmitted affiliated store list is not only obtained but also is displayed on the display of the client device 2210 by the dedicated application 4210.

Here, the user 1200 is able to check the descriptions consisting of texts of the sales promotion planning data 7052 included in the transmitted affiliated store list or to check images of the image data. For example, when the user selects his/her favorite affiliated store 1400 from the affiliated store list, not only the use guide ID 7051 included in the selection information of the affiliated store 1400 is obtained in the time management system 4110, but also the condition management program 5120 is executed. Through this execution, the use guide data 6051 of the affiliated store 1400 is extracted from the affiliated store guide database 3050 on the basis of the obtained use guide ID 7051. When the extracted use guide data 6051 is transmitted to the client device 2210 through the Internet 1900, the transmitted use guide data 6051 of the affiliated store 1400 is obtained by the dedicated application 4210 and is displayed on the display of the client device 2210. Also, the user is provided with the ┌guide to the use of affiliated store┘ which relates to the consumption condition of the time point or the store information of the affiliated store 1400, etc., and is composed of texts, images, videos, etc.

As such, by the ┌guide to the use of affiliated store┘ registration process and ┌guide to the use of affiliated store┘ providing method, the sales promotion planning related to the time point use (consumption) by the affiliated store is efficiently notified to the user.

In addition, it has been already known that the location notifying device including a known radio transmitter is able to adjust a detection distance of the radio transmitter of the location notifying device by the known radio wave detector provided to the client device, that is to say, a detection distance between the location notifying device and the client device, by means of a known adjustment method for, for example, adjusting the output of the radio transmitter or covering with a material having a different radio wave transmittance, etc.

Accordingly, the user is able to easily find the member store which issues the time point, i.e., the sales promotion point based on a unit of time, to simply collect the time point issued by the member store, to easily find the affiliated store where the user consumes the time point, and to simply convert the collected time point into the goods or services for sales promotion provided by the affiliated store.

According to the present invention, on the basis of the sale price standard of the time-based service that is as a sales target, in other words, on the basis of the sale price (Yen/min) of the time-based service per a unit time, the facilities-based service provider, the treatment-based service provider, or the net-based service provider, etc., who sells a service that charges on the basis of time (a time-based service), as the aforementioned member store, calculates the number of the time points (min/min) that the customer pays when the “sales promotion time” according to the time-based service is provided to the customer, that is to say, calculates the time point sale price for the “sales promotion time” of the time-based service, and registers the calculated time point sale price by the aforementioned “predetermined guide registration operation related to the ┌guide to the use of affiliated store┘” as the consumption condition parameter. Then, it is possible to easily transmit the sales promotion contents of the store itself to the user who possesses the time point and also possible to easily provide the “sales promotion time” of the time point sale price to the user who visits the store in order to use the sales promotion contents.

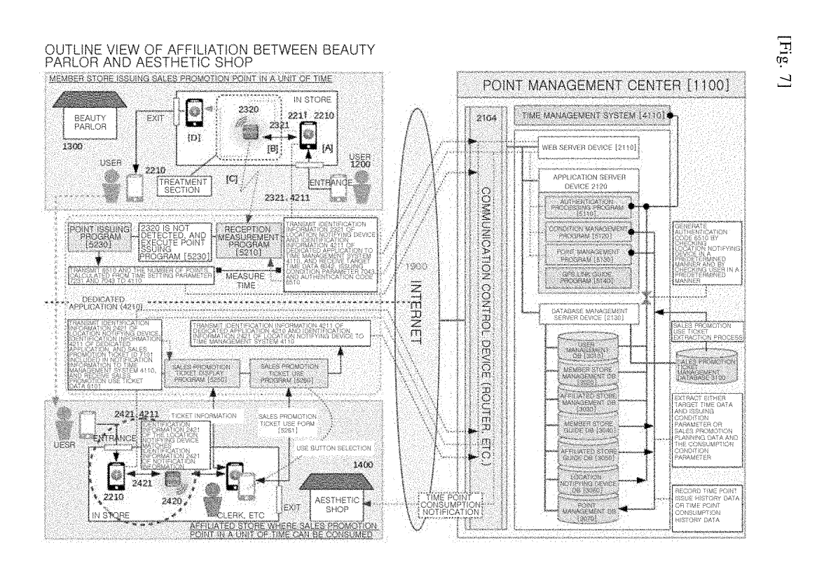

The association between the member store and affiliated store will be described on the basis of the outline view of FIG. 7 showing that the aforementioned beauty parlor and aesthetic shop function as the member store 1300 and the affiliated store 1400 respectively.

First, in the member store 1300 corresponding to the beauty parlor, it is assumed that a (treatment) time normally required for “cut & shampoo” is 50 minutes. For example, in order to list the ┌member store guide┘ that includes content that the time point is issued for the “excess waiting time” of the “cut & shampoo”, through a predetermined guide set operation of the guide set form 5381 (FIG. 5) described in the aforementioned [┌member store guide┘ registration process], first, the member store 1300 selects, in a target time set field, the “excess waiting time” as a target time for the issuance of the time point, or inputs “cut & shampoo waiting time” as a title in the form of a text, and furthermore, selects and sets related images or videos from a local disk. Next, in the issuing condition set field, the basic rate Rs is set to 1 and 0 is input to the set rate Rn. Furthermore, the (treatment) time normally required for “cut & shampoo”, i.e., “50 minutes” is input as the adjustment time Ct, so that the guide data 6041 (FIG. 18) is registered and the location notifying device 2320 is installed at a particular place (herein, a treatment section of the “cut & shampoo”) and is driven.

Here, when the user 1200 who possesses the aforementioned radio wave detector 2211 and the client device 2210 which has the dedicated application 4210 installed therein drives the dedicated application 4210, visits the member store 1300, orders the “cut & shampoo”, and enters the treatment section, the Bluetooth-standardized radio wave transmitted from the location notifying device 2320 is detected by the radio wave detector 2211 of the client device 2210. The identification information 2321 of the location notifying device 2320 is obtained by the dedicated application 4210, and the obtained identification information 2321 and identification information 4211 of the dedicated application 4210 are transmitted to the time management system 4110 of the point management center 1100 through Internet 1900.

When the time management system 4110 receives the identification information 2321 and the identification information 4211, the authentication processing program 5110 of the application server device 2120, which constitutes the time management system 4110, is, as described in the aforementioned [predetermined issuing operation by the user], executed. Through the execution of the authentication processing program 5110, the location notifying device is checked in a predetermined manner and the user is checked in a predetermined manner on the basis of the received identification information 2321 and the identification information 4211, and then the authentication code 6510 consisting of the identification information 4211 and identification information 2321 is formed. Furthermore, the condition management program 5120 of the application server device 2120 is executed. Through this execution, not only the guide data 6041 set by the member store 1300 is extracted from the member store guide database 3040 shown in FIG. 18, but also the target time data 8042 set in the issuance target data 7042 of the extracted guide data 6041, the issuing condition parameter 7043, and the formed authentication code 6510 are transmitted to the client device 2210 through the Internet 1900, and the transmitted target time data 8042, the issuing condition parameter 7043, and the authentication code 6510 are obtained by the dedicated application 4210.

Also, as described in the aforementioned [time measurement processing on the issuing operation], the target time data 8042 and the authentication code 6510 which have been obtained by the dedicated application 4210 are first set to a measurement parameter 7211 of the reception measurement program 5210 constituting the dedicated application 4210, so that the reception measurement program 5210 is executed. Through this execution, in accordance with the setting of the measurement starting time of the target time data 8042 (herein, the execution time of the reception measurement program 5210 is set to the measurement starting time), not only the execution time of the reception measurement program 5210 is obtained as the measurement starting time Ts, but also the time is measured as long as the Bluetooth-standardized radio wave transmitted from the location notifying device 2320 is detected by the radio wave detector 2211 included in the client device 2210. Next, when the treatment of the “cut & shampoo” is completed and the user 1200 comes out from the treatment section, the radio wave detector 2211 included in the client device 2210 does not detect the Bluetooth-standardized radio wave transmitted from the location notifying device 2320 for more than the error setting time Er, and the execution of the reception measurement program 5210 is ended. Also, in accordance with the setting of the measurement end time of the target time data 8042 (herein, the execution end time of the reception measurement program 5210 is set to the measurement end time), the time at which the execution of the reception measurement program 5210 is ended is obtained as the measurement end time Te, and a staying time of the user 1200 in the treatment section is measured.

As above, the measurement starting time Ts, the measurement end time Te, and the error setting time Er which have been obtained by the dedicated application 4210 are, as described in the aforementioned [calculation of issuing point based on the time measurement processing], input to the starting time field, the end time field, or the error time field of the time setting parameter 7231, respectively. On the basis of the issuing condition parameter 7043, the time point that is issued to the user 1200 is calculated.

Here, for example, when, on the basis of the measurement starting time Ts, the measurement end time Te, and the error setting time Er, the staying time of the user 1200 in the treatment section, that is to say, the actually measured time St that is determined by an equation {St=(Te−Ts−Er)} is 90 minutes, the number Ep of the time points issued to the user 1200 is calculated by the following equation on the basis of a set value by the above-description of the issuing condition parameter 7043, that is to say, 1 of the basic rate Rs and “50 minutes” of the adjustment time Ct.

Equation {Ep=(St−Ct)×Rs}=(90 min−50 min)×1=40 TP (TP is a unit of the time point)

Next, in the affiliated store 1400 corresponding to the aesthetic shop, it is assumed that a new treatment service “foot massage 20 minutes, fee of 800 Yens” is started. The affiliated store 1400 plans “1 minute test” as a sales promotion of the “foot massage”. For example, in order to list the ┌guide to the use of affiliated store┘ that provides the time point sale price 40 TP according to the sale price standard of the “foot massage” (treatment fee 800 Yen÷treatment time 20 minute=40 Yen/min), through a predetermined guide set operation of the use guide set form 5481 (FIG. 6) described in the aforementioned [predetermined registration operation related to the ┌guide to the use of affiliated store┘], first, the affiliated store 1400 selects, in the sales promotion planning set field, the “test sales promotion time” as a sales promotion item or inputs “1 minute test of foot massage” as a title in the form of a text, and furthermore, selects and sets related images or videos from a local disk. Next, in the consumption condition set field, the treatment time 20 minute of the “foot massage” is input as the sale time Tn, and the treatment fee 800 Yen of the sale time Tn is input as the sale price Ps. Furthermore, the sales promotion time 1 minute that is provided to the user is input as a sales promotion time Tp by the sales promotion planning, so that the use guide data 6051 (FIG. 19) is registered and the location notifying device 2420 is installed and driven.

### Sales Promotion Use Ticket Issuing Process

Herein, a method for using (consuming) the time point 40 TP during the sales promotion time of 1 minute can be simply implemented by adding a later-described configuration of a sales promotion use ticket issuing process.

As shown in the outline view of FIG. 8, for example, when the user 1200 possessing the aforementioned issued time point of 40 TP uses the dedicated application 4210 of the client device 2210 owned by the user 1200 and obtains, by the method described in the [┌guide to the use of affiliated store┘ providing method], the ┌guide to the use of affiliated store┘ on the sales promotion planning “1 minute test of foot massage” of the affiliated store 1400 listed in the affiliated store list, an item “the sales promotion use ticket issued by using the time point of 40 TP” is displayed in the obtained ┌guide to the use of affiliated store┘. Then, when the item is selected, not only the use guide ID 7051 included in the selection information of the item is obtained by the dedicated application 4210 of the client device 2210, but also the obtained use guide ID 7051 and the identification information 4211 of the dedicated application 4210 are transmitted to the time management system 4110 through the Internet 1900. In the time management system 4110, first, when the transmitted identification information 4211 is correctly checked by the predetermined user check process which has been described in the [predetermined consuming operation by the user] and is performed by the authentication processing program 5110 of the application server device 2120, which constitutes the time management system 4110, not only the user ID 7011 (FIG. 15) of the user 1200, which corresponds to the identification information 4211, is obtained, but also the sales promotion use ticket issuing process is performed by the condition management program 5120 and the point management program 5130 of the application server device 2120.

In the sales promotion use ticket issuing process, first, not only the use guide data 6051 corresponding to the use guide ID 7051 is detected by the condition management program 5120 from the affiliated store guide database 3050 shown in FIG. 19, but also the sales promotion planning data 7052 and the consumption condition parameter 7053 are extracted from the detected use guide data 6051. Furthermore, not only a sales promotion use ticket data 6101 including the extracted sales promotion planning data 7052, the extracted consumption condition parameter 7053, the user ID 7011, and a sales promotion ticket ID 7101 consisting of a process separation 8101 corresponding to the “issuance” of the sales promotion use ticket is generated, but also the sales promotion use ticket data 6101 is recorded in a sales promotion ticket management database 3100 by using the database management server device 2130 in accordance with the a record-layout of the sales promotion ticket management database shown in FIG. 22. Next, by the point management program 5130, a point ID 7071 consisting of the user ID 7011 and a process separation 8072 corresponding to the “filling” of the time point, and a point data 6071 including the date and time of the registration and a calculation result based on the consumption condition parameter 7053 described in the [calculation of consumption point based on the time measurement processing], in other words, a time point data 7072 composed of the number of the consumed time points (point sale price 40 TP) given by an equation {Cp=(Ps÷Tn)×Tp}={(800 Yen÷20 min)×1 min} are recorded in the point management database 3070 by using the database management server device 2130 in accordance with a record-layout of the point management database shown in FIG. 21 and ended.

When the sales promotion use ticket issuing process is completed, the affiliated store ID 7031 of the use guide ID 7051 is used as a search key by the authentication processing program 5110, and not only the identification information 2421 of the location notifying device 2420 installed in the affiliated store 1400 corresponding to the affiliated store ID 7031 is extracted from the location notifying device database 3060 (FIG. 20) of the time management system 4110, but also notification information is generated, which consists of the extracted identification information 2421, the sales promotion ticket ID 7101 of the sales promotion use ticket data 6101, and the identification information 4211 of the dedicated application 4210. When the generated notification information is transmitted to the client device 2210 through the Internet 1900, not only the transmitted notification information is obtained by the dedicated application 4210 of the client device, but also the notification information is displayed on the display of the client device 2210. Furthermore, the notification information is recorded in a storage device of the client device 2210.

In addition, the notification information transmitted to the client device 2210 is, for example, provided as a known text file including text data of the identification information 2421, the sales promotion ticket ID 7101, and the identification information 4211 or as a known QR code data based on the text data. When the Bluetooth-standardized radio wave transmitted from the location notifying device installed in the member store or affiliated store is detected by the radio wave detector 2211 included in the client device 2210, the radio wave is first referred to by the dedicated application 4210 of the client device 2210. For example, the text data included in the text file is obtained by the dedicated application 4210, so that the aforementioned reception measurement program 5210 is executed. Or the QR code data based on the text data is displayed on the display of the client device 2210 by the dedicated application 4210, so that the QR code data is read by a barcode reader of the member store or affiliated store.

### Use Confirmation Process of Sales Promotion Use Ticket

The sales promotion use ticket issued as described above is, as shown in the outline view of FIG. 8, used as below by the user 1200.

First, the user 1200 drives the dedicated application 4210 of the client device 2210 and visits the affiliated store 1400. When the Bluetooth-standardized radio wave transmitted from the location notifying device 2420 of in the affiliated store 1400 is detected by the radio wave detector 2211 included in the client device 2210, not only the ticket information is referred to by the dedicated application 4210, but also the identification information 2421, the sales promotion ticket ID 7101, and the identification information 4211 which have been included in the ticket information are obtained. Furthermore, the identification information 2421 of the location notifying device 2420 is obtained. Both when the obtained identification information 2421 of the ticket information matches the identification information 2421 of the location notifying device 2420 and when the obtained identification information 4211 of the ticket information matches the identification information 4211 of the dedicated application 4210, the obtained sales promotion ticket ID 7101 of the ticket information, the identification information 2421 of the location notifying device 2420, and the identification information 4211 of the dedicated application 4210 are transmitted to the time management system 4110 of the point management center 1100 through the Internet 1900 by the dedicated application 4210.

When the time management system 4110 receives the sales promotion ticket ID 7101, the identification information 2421, and the identification information 4211, the authentication processing program 5110 of the application server device 2120, which constitutes the time management system 4110, is executed. Through this execution, the transmitted identification information 2421 of the location notifying device 2420 is correctly checked by checking the location notifying device in a predetermined manner as described in the aforementioned [predetermined consuming operation by the user]. Also, when the transmitted identification information 4211 of the dedicated application 4210 is correctly checked by checking the user in a predetermined manner, not only the authentication code 6510 consisting of the identification information 2421 of the location notifying device 2420 and the identification information 4211 of the dedicated application 4210 is generated, but also a sales promotion use ticket extraction process is performed.

The sales promotion use ticket extraction process is performed by executing the condition management program 5120 of the application server device 2120. By doing this, not only the sales promotion use ticket data 6101 (FIG. 22) corresponding to the sales promotion ticket ID 7101 is extracted from the sales promotion ticket management database 3100 of the time management system 4110, but also the authentication code 6510 and a sales promotion ticket use form including the extracted sales promotion use ticket data 6101 are transmitted from the time management system 4110 to the client device 2210 through the Internet 1900. When the authentication code 6510 and the sales promotion ticket use form including the transmitted sales promotion use ticket data 6101 are obtained by the dedicated application 4210 of the client device 2210, a sales promotion ticket display process is performed.

The sales promotion ticket display process is performed by executing a sales promotion ticket display program 5250 constituting the dedicated application 4210. Through this execution, not only the sales promotion use ticket data 6101 obtained by the dedicated application 4210 is displayed on the display of the client device 2210, but also a “use button” is provided on the display of the client device 2210 by the sales promotion ticket use form.

Additionally, the sales promotion ticket display program 5250 constituting the dedicated application 4210 includes a rendering engine that interprets a known HTML, CSS, JavaScript, etc. For example, WebKit is a representative open source thereof.

Also, the sales promotion ticket use form consists of the known HTML, CSS, JavaScript, etc. The sales promotion planning data 7052 (FIG. 22) composed of texts, images, videos, etc., of the sales promotion use ticket data 6101 is efficiently displayed on the display of the client device 2210 by the sales promotion ticket display program 5250.

### Time Point Consumption Process Based on the Use of the Sales Promotion Use Ticket

Here, as shown in the outline view of FIG. 8, when the user 1200 presents the sales promotion ticket use form displayed on the display of the client device 2210 to employees of the affiliated store 1400 and clicks (touches) the “use button”, a time point consumption process based on the use of the sales promotion use ticket by the user 1200 is performed as below.

When the user 1200 clicks (touches) the “use button”, not only the sales promotion ticket ID 7101 of the sales promotion use ticket data 6101, the authentication code 6510, and the identification information 4211 of the dedicated application 4210 are submitted (data input) to the time management system 4110 through the sales promotion ticket use form, but also the authentication processing program 5110 of the application server device 2120, which constitutes the time management system 4110, is executed. Through the execution of the authentication processing program 5110, when the identification information 2421 of the location notifying device 2420 installed in the affiliated store 1400, which constitutes the submitted authentication code 6510, is correctly checked by checking the location notifying device in a predetermined manner as described in the aforementioned [time point consumption history data management process], the affiliated store ID 7031 (FIG. 17) of the affiliated store 1400, which corresponds to the identification information 2421, is obtained. When the identification information 4211 of the dedicated application 4210, which constitutes the submitted authentication code 6510, is correctly checked by checking the user in a predetermined manner, the user ID 7011 (FIG. 15) of the user 1200, which corresponds to the identification information 4211 is obtained and the time point consumption process is performed.

The time point consumption process is performed by executing the point management program 5130 of the application server device 2120. Through this execution, not only the point ID 7071 which consists of the user ID 7011 and the process separation 8072 corresponding to the “consumption” of the time point, and the point data 6071 which includes the affiliated store ID 7031 and the date and time of the registration of the consumption process, etc., are recorded in the point management database 3070 in accordance with a record-layout of the point management database shown in FIG. 21, but also the process separation 8101 corresponding to the “issuance” of the sales promotion ticket recorded in the sales promotion use ticket data 6101 of the sales promotion ticket management database 3100 (FIG. 22) corresponding to the sales promotion ticket ID 7101 is changed into the process separation 8101 corresponding to the “use” of the ticket. Furthermore, if necessary, for example, as shown in FIG. 8, a time point consumption notification is transmitted to the affiliated store 1400 by an email, etc.

Accordingly, the user is able to convert the time point 40 TP issued by the “excess waiting time” in the beauty parlor into the sales promotion use ticket (point sale price 40 TP) of the aesthetic shop, thereby changing the unpleasant time the into the pleasant time.

As described above, when the time point is distributed, the customer, first, collects the time point that is issued by the “waiting time” in the member store. Then, from the time point collected for the service corresponding to the “sales promotion time” provided from the affiliated store, the customer is able to receive a service corresponding to the “sales promotion time” only by, for example, spending (consuming) the time point corresponding to the time point sale price calculated by the sale price standard of the “sales promotion time”. As a result, it is possible to convert the unpleasant time so called “waiting time” into the pleasant time so called “sales promotion time”. Also, without necessarily caring about the issuance cost which does not achieve a balance with the user's revisiting the store, and without necessarily paying a cost related to a financial settlement process between the issuer and the consumption provider, the member store that has limited goods or services is able to enhance a customer service by means of sales promotion goods or service of the affiliated store, which is provided through the time point. Furthermore, an affiliated store that has a limited advertising budget is able to obtain a sales opportunity by increasing a customer touch point through the time point. As a result, a virtuous cycle model of the sales promotion is realized, which allows the member store and the affiliated store to complement each other's business and to improve the customer's satisfaction.

In the above-described first embodiment, the client device such as a smartphone (a cellular phone) that is operated by the user functions as an electronic wallet “which collects and uses time” only by installing the dedicated application of the present invention. Therefore, the member store of the affiliated store is able to issue the time point, i.e., the sales promotion point which is based on a unit of time, to the user, or able to receive the consumption of the time point from the user, only by, for example, installing the location notifying device to which a small and cost-effective Bluetooth-standardized transmitter has been adopted. Accordingly, without installing the above-described expensive point issuing device, the time point distribution makes it for the member store to meet goods or services which cannot be provided by itself and makes it for the affiliated store to obtain sales promotion opportunities without paying a cost.

In addition, a time measurement target, i.e., the issuing condition and the consumption condition of the sales promotion point which is based on a unit of time, is not limited to the Bluetooth-standardized radio wave transmitted by the location notifying device. The time measurement target may be configured to, for example, measure a sound wave or an electromagnetic wave such as a WiFi-standardized radio wave, etc.

Also, a method for measuring a predetermined elapsed period of time of the user at a particular place is not limited to the method for using the location notifying device and can be easily implemented, for example, by adding a configuration in which a smartphone (cellular phone) which has a known GPS receiver and a GPS function is adopted to the client device possessed by the user and location information of the client device obtained by the GPS function is obtained by the dedicated application, and also by adding location data corresponding to the installation place of the location notifying device installed in the member store or the affiliated store to the guide data or the use guide data which is recorded in the member store guide database or the affiliated store guide management database, and furthermore by assigning, for example, a GPS corresponding code of 900s to the industry code of the guide data or the industry code of the use guide data.

Through the addition of the above method, a method is added which provides the member store list or the affiliated store list to the user by the item selection of the ┌member store guide┘ or the ┌guide to the use of affiliated store┘ from the “service menu” described in the aforementioned [┌member store guide┘ providing method] or [┌guide to the use of affiliated store┘ providing method]. The member store list or the affiliated store list can be, for example, automatically provided by means of a method to be described in a below-described [┌GPS link guide┘ providing method] in accordance with the current location of the user possessing the client device that has the GPS function. Also, in the communication process between the client device and the time management system, it is possible to successively check the current location of the client device and the location information of the member store or the affiliated store. Also, a predetermined elapsed period of time of the user at a particular place can be measured equivalently to or more than a method for checking where the user is by the radio wave transmitted by the location notifying device and by the radio wave detector of the client device.

This is implemented by installing a below-described “GPS link guide program” on the application server device constituting the time management system of the point management center, and also by installing a below-described “location measurement program” on the dedicated application of the client device.

### ┌GPS Link Guide┘ providing Method

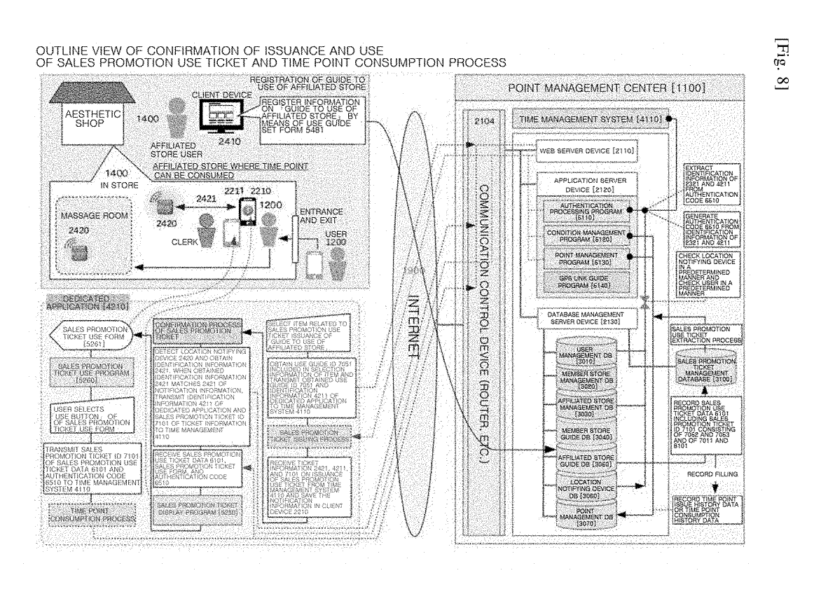

As shown in the outline view of FIG. 9, first, when the user 1200 possessing the client device 2210 in which the dedicated application 4210 having a known GPS receiver and the GPS function and including a location measurement program 5220 has been installed drives the dedicated application 4210 in or in the vicinity of the member store 1300 or the affiliated store 1400 and selects an item of ┌GPS link guide┘ from the “service menu” displayed through the predetermined login process described in the aforementioned [┌member store guide┘ providing method] or [┌guide to the use of affiliated store┘ providing method], the location measurement program 5220 of the dedicated application 4210 is executed. Through this execution, a positioning data of the current location which is measured by the GPS function is regularly obtained as a client location data 2220 (Latitude Xc, Longitude Yc). The regularly obtained client location data 2220 (Latitude Xc, Longitude Yc) and the identification information 4211 of the dedicated application 4210 are regularly transmitted to the time management system 4110 of the point management center 1100 through the Internet 1900. When the regularly transmitted client location data 2220 (Latitude Xc, Longitude Yc) and the identification information 4211 are obtained by the time management system 4110, a GPS link guide generation process is performed in the time management system 4110.

The GPS link guide generation process is performed by a GPS link guide program 5140 of the application server device 2120, which constitutes the time management system 4110. Through the performance of the program, the guide ID 7041 and the issuance target data 7042 which have a member store location data 8021 (Latitude Pxn, Longitude Pyn) within a range on the condition of a search location data (Latitude Xc±α, Longitude Yc±α) obtained by adding or subtracting a predetermined value a to and from the obtained client location data 2220 (Latitude Xc, Longitude Yc), and the use guide ID 7051 and the sales promotion planning data 7052 which have an affiliated store location data 8031 (Latitude Axn, Longitude Ayn) within the same range are sequentially searched in the member store guide database 3040 shown in FIG. 18 or in the affiliated store guide database 3050 shown in FIG. 19 respectively. When the guide ID 7041 or the use guide ID 7051 which is suitable for the condition is detected by the searching, the member store list including the issuance target data 7042 and the guide ID 7041 which have the member store location data 8021 (Latitude Pxn, Longitude Pyn) or the affiliated store list including the sales promotion planning data 7052 and the use guide ID 7051 which have the affiliated store location data 8031 (Latitude Axn, Longitude Ayn) is generated. The generated member store list or the generated affiliated store list is sequentially transmitted to the client device 2210 through the Internet 1900.

By doing this, the sequentially transmitted member store list or the sequentially transmitted affiliated store list is not only obtained by the dedicated application 4210, but also is displayed on the display of the client device 2210. Meanwhile, the member store location data 8021 (Latitude Pxn, Longitude Pyn) of the guide ID 7041 included in the transmitted member store list or the affiliated store location data 8031 (Latitude Axn, Longitude Ayn) of the use guide ID 7051 included in the affiliated store list is sequentially obtained by the location measurement program 5220 of the dedicated application 4210.

### Time Measurement Processing by the GPS Function

Here, as shown in the outline view of FIG. 9, the location measurement program 5220 compares the member store location data 8021 (Latitude Pxn, Longitude Pyn) or the affiliated store location data 8031 (Latitude Axn, Longitude Ayn) which has been sequentially obtained by the location measurement program 5220 with the client location data 2220 (Latitude Xc, Longitude Yc) based on the positioning data of the current location which is measured by the GPS function. It is determined whether the member store location data 8021 (Latitude Pxn, Longitude Pyn) or the affiliated store location data 8031 (Latitude Axn, Longitude Ayn) is within a range on the condition of a staying location data (Latitude Xc±β, Longitude Yc±β) obtained by adding or subtracting a predetermined value β to and from the client location data 2220 (Latitude Xc, Longitude Yc). For example, if it is first determined “Yes”, the time measurement is started and the time measurement continues for the subsequent “Yes” determination. When it is determined “No” during the continuation of the time measurement, the time measurement is terminated.

Specifically, with regard to a relationship between the predetermined values α and β, for example, when α is set to be larger than β (α>β), by the location measurement program 5220, first, in (Z) of FIG. 9, the member store list or the affiliated store list is only displayed by the dedicated application 4210 because the search location data is determined to be “Yes” and the staying location data is determined to be “No”. However, in (Y) of FIG. 9, the search location data is determined to be “Yes” and the staying location data is also determined to be “Yes”, and the first determination regarding the staying location data is “Yes”. Therefore, the time measurement is started. Also, as long as the client device is located in (Y) of FIG. 9, the search location data is determined to be “Yes” and the staying location data is determined to be “Yes”, so that the time measurement continues. Furthermore, in (X) of FIG. 9, on the basis of the relationship between α and β (α>β), the staying location data is determined to be “No” while the search location data is determined to be “Yes”, so that the time measurement is terminated.

As such, a predetermined elapsed period of time of the user at a particular place can be measured even by the above method using the GPS function and the location measurement program 5220. Therefore, the time point described in the [calculation of issuing point based on the time measurement processing] or in the [calculation of consumption point based on the time measurement processing] can be calculated by the above method.

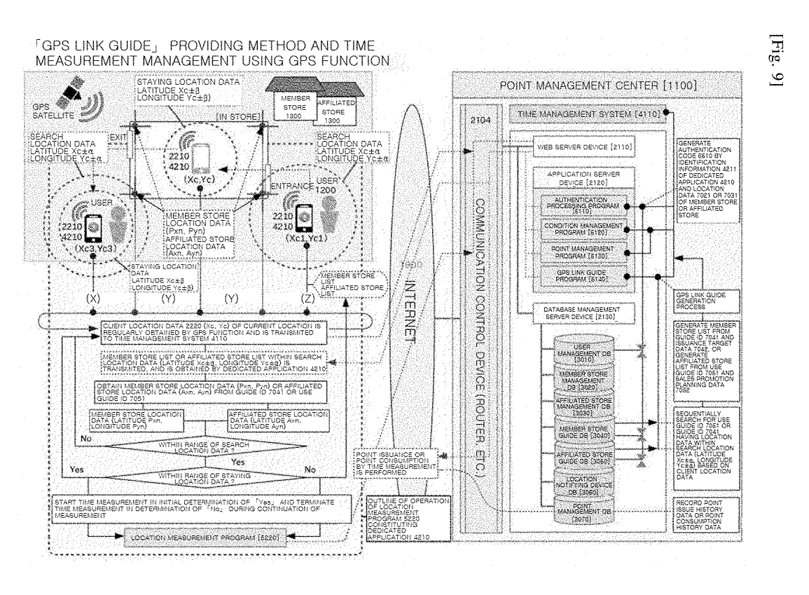

Additionally, the location measurement program 5220 which obtains the location information of the client device by using the GPS function in the dedicated application 4210 is developed by utilizing various application programming interfaces (API) disclosed at the time of filing the present application and by using programming languages such as Java, C, C++, etc. ┌Google Maps JavaScript API (https://developers.google.com/maps/documentation/javascript/examples/map-geolocation?hl=ja)┘ shown in FIG. 10 may be taken as a representative example of an API using Geolocation of which the specification is determined by World Wide Web Consortium (W3C).

As described above, when the GPS link guide program is installed in the application server device constituting the time management system of the point management center and when the location measurement program is installed in the dedicated application of the client device, a tollgate on a highway or a toll road is determined to be the member store and a particular store within a service area of the tollgate is determined to be the affiliated store, so that an excess time Ta is calculated by a difference (Td−Tr) between a driving time Td of a vehicle equipped with the client device in a certain section of the highway or toll road and a time Tr required for the vehicle to travel at a speed limit without a traffic jam in the section. For example, when the time point corresponding to the excess time Ta is issued by the point management center, the issued time point (Pt) can be used (consumed) by the “sales promotion time” provided by the particular store within the service area determined to be the affiliated store. For example, when it is assumed that the vehicle is in a traffic jam with a large width in the section and the excess time Ta is 60 minutes, and then the time point of 60 TP is generated, and when it is also assumed that the “sales promotion time” of the particular store is used for a massage to relieve the fatigue of a driver (normal price is 300 Yen per 5 minutes, and the time point sale price according to the sale price standard of the “sales promotion time” of 1 minute is 60 TP), the driver tired of driving is able to receive the massage at the normal price of 300 Yen for 6 minutes increased by the “sales promotion time” of 1 minute in accordance with the time point of 60 TP.

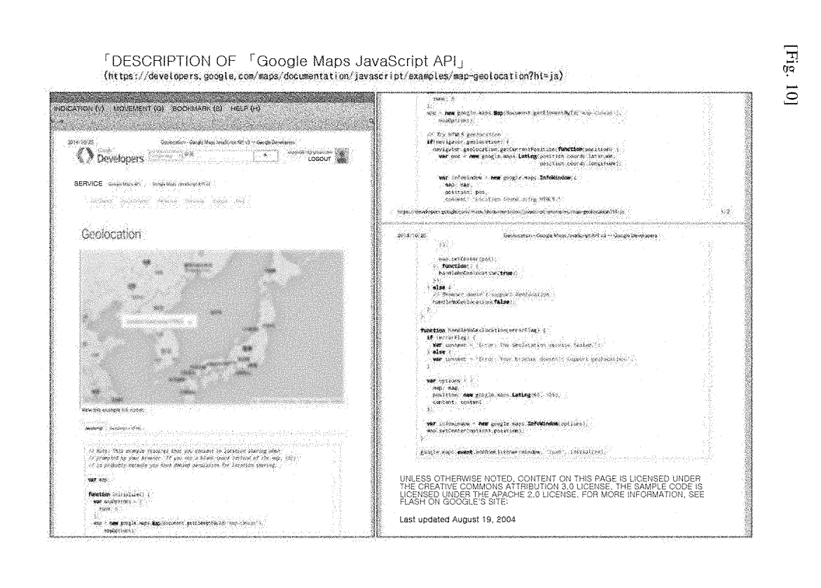

Herein, the above configuration will be described in detail on the basis of the outline view of FIG. 11.

First, when the GPS link guide program 5140 is installed on the application server device 2120 constituting the time management system 4110 of the point management center 1100, not only the member store location data 8021 composed of the latitude Pxn and the longitude Pyn is added to the guide data 6041 of the member store guide database 3040 shown in FIG. 18, but also the affiliated store location data 8031 composed of the latitude Axn and the longitude Ayn is added to the use guide data 6051 of the affiliated store guide database 3050 shown in FIG. 19. Furthermore, the component of the authentication code 6510 described in the aforementioned [predetermined issuing operation by the user] or in the aforementioned [predetermined consuming operation by the user] is based on the premise of the change of a configuration including the identification information 4211 of the dedicated application 4210, the member store location data 8021 (Latitude Pxn, Longitude Pyn), and the affiliated store location data 8031 (Latitude Axn, Longitude Ayn).

Also, the client device 2210 possessed by the user 1200 is a mobile terminal such as a smartphone (mobile phone), a tablet PC, etc., which includes the known GPS function and the known radio wave detector detecting the Bluetooth-standardized radio wave. The dedicated application 4210 (FIG. 4) is composed of the reception measurement program which measures time while monitoring the radio wave reception state of the radio wave detector, the location measurement program 5220 which obtains the positioning data of the current location measured by the GPS function and measures time, and the point issuing program which manages the issuance of the time point, or the point consuming program which manages the consumption of the time point. The dedicated application 4210 is installed on the client device 2210.

Next, in the certain section of the highway or toll road, a first section (latitude Ax1±Px1, longitude Ay1±Py1) is defined as from a first tollgate 1701 (Px1, Py1) determined by the member store location data 8021 composed of a latitude Px1 and a longitude Py1 to a first particular store 1801 (latitude Ax1, longitude Ay1) within the service area determined by the affiliated store location data 8031 composed of a latitude Ax1 and a longitude Ay1. Also, a second section (latitude Px2±Ax1, longitude Py2±Ay1) is defined as from the first particular store 1801 (latitude Ax1, longitude Ay1) to a second tollgate 1702 (latitude Px2 and longitude Py2) determined by the member store location data 8021 composed of a latitude Px2 and a longitude Py2.

It is assumed that the user 1200 possessing the client device 2210 drives the dedicated application 4210 of the client device, selects the ┌GPS link guide┘ from the “service menu” displayed through the predetermined login process described in the aforementioned [┌member store guide┘ providing method] or [┌guide to the use of affiliated store┘ providing method] and then gets in the vehicle 1600, and travels on the first section (Px2±Px1, Py2±Py1) and on the second section (Ax1±Px2, Ay1±Py2).

Here, based on the above premise, the process shown in the outline view of FIG. 9 in the aforementioned [┌GPS link guide┘ providing method] is repeated in a communication between the client device 2210 and the time management system 4110.

First, as a first process, the positioning data of the current location which is measured by the GPS function is regularly obtained as the client location data 2220 (Latitude Xc, Longitude Yc) by the location measurement program 5220 constituting the dedicated application 4210 of the client device 2210. The regularly obtained client location data 2220 (Latitude Xc, Longitude Yc) and the identification information 4211 of the dedicated application 4210 are regularly transmitted to the time management system 4110 of the point management center 1100 through the Internet 1900.

Next, as a second process, when the regularly transmitted client location data 2220 (Latitude Xc, Longitude Yc) and the identification information 4211 are obtained by the time management system 4110, the GPS link guide program 5140 of the application server device 2120, which constitutes the time management system 4110, is executed. Through this execution, the guide ID 7041 and the issuance target data 7042 which have the member store location data (Latitude Pxn, Longitude Pyn) within a range on the condition of the search location data (Latitude Xc±α, Longitude Yc±α) obtained by adding or subtracting a predetermined value a to and from the obtained client location data 2220 (Latitude Xc, Longitude Yc), and the use guide ID 7051 and the sales promotion planning data 7052 which have the affiliated store location data (Latitude Axn, Longitude Ayn) within the same range are sequentially searched in the member store guide database 3040 or in the affiliated store guide database 3050 respectively. When the guide ID 7041 or the use guide ID 7051 which is suitable for the condition is detected by the searching, the member store list including the issuance target data 7042 and the guide ID 7041 which have the member store location data (Latitude Pxn, Longitude Pyn) or the affiliated store list including the sales promotion planning data 7052 and the use guide ID 7051 which have the affiliated store location data (Latitude Axn, Longitude Ayn) is generated. The generated member store list or the generated affiliated store list is sequentially transmitted to the client device 2210 through the Internet 1900.

Also, as a third process, by doing this, the sequentially transmitted member store list or the sequentially transmitted affiliated store list is not only obtained by the dedicated application 4210, but also is displayed on the display of the client device 2210. Meanwhile, the member store location data (Latitude Pxn, Longitude Pyn) of the guide ID 7041 included in the transmitted member store list or the affiliated store location data (Latitude Axn, Longitude Ayn) of the use guide ID 7051 included in the affiliated store list is sequentially obtained by the location measurement program 5220 of the dedicated application 4210.

That is to say, such processes are repeated by the selection of the ┌GPS link guide┘ by the user 1200.

In the above-described processes, for example, as shown in the outline view of FIG. 11, around the time the user passes through the first tollgate 1701 (Px1, Py1), in the second process, when the guide ID 7041 having the industry code 7022 (FIG. 18) of the GPS corresponding code ┌highway tollgate 901┘ suitable for the condition of the search location data (Latitude Xc±α, Longitude Yc±α) is detected by the GPS link guide program 5140, the authentication processing program 5110 of the application server device 2120, which constitutes the time management system 4110 is executed. Through the execution of the authentication processing program 5110, not only the authentication code 6510 consisting of the identification information 4211 and the member store location data (Latitude Pxn, Longitude Pyn) included in the guide ID 7041 is generated, but also the issuing condition parameter 7043 of the guide data 6041, which corresponds to the guide ID 7041, is extracted from the member store guide database 3040. Then, the authentication code 6510 and the issuing condition parameter 7043 are transmitted to the client device 2210 through the Internet 1900. When the transmitted authentication code 6510 and the issuing condition parameter 7043 are obtained by the dedicated application 4210 of the client device, the authentication code 6510 and the issuing condition parameter 7043 are set to a measurement parameter 7221 of the location measurement program 5220 by the dedicated application 4210, and then the location measurement program 5220 is executed. Through this execution, the time measurement begins and an execution time of the location measurement program 5220 is obtained as the measurement starting time Ts by the dedicated application 4210.

Also, for example, around the time the user passes through the first particular store 1801 (latitude Ax1, longitude Ay1), as with the second process, when the use guide ID 7051 having the industry code 7032 (FIG. 19) of the GPS corresponding code ┌SA store 902┘ suitable for the condition of the search location data (Latitude Xc±α, Longitude Yc±α) is detected by the GPS link guide program 5140, the authentication processing program 5110 of the time management system 4110 is executed. Through the execution of the authentication processing program 5110, not only the authentication code 6510 consisting of the identification information 4211 and the affiliated store location data (Latitude Axn, Longitude Ayn) included in the use guide ID 7051 is generated, but also the consumption condition parameter 7053 of the use guide data 6051, which corresponds to the use guide ID 7051, is extracted from the affiliated store guide database 3050. Then, the authentication code 6510 and the consumption condition parameter 7053 are transmitted to the client device 2210 through the Internet 1900. When the transmitted authentication code 6510 and consumption condition parameter 7053 are obtained by the dedicated application 4210 of the client device, the authentication code 6510 and the consumption condition parameter 7053 are set to the measurement parameter 7221 of the location measurement program 5220 by the dedicated application 4210, and then the location measurement program 5220 is executed. Through this execution, for example, when the flag code corresponding to “measurement continuation” is detected in the transmitted consumption condition parameter 7053, not only the detected time is obtained as a first middle time Tp1 by the dedicated application 4210, but also the obtained first middle time Tp1 is made to correspond to the measurement end time Te and a time point Ep1 from the measurement starting time Ts to the first middle time Tp1 is calculated in the same manner as that described in the aforementioned [calculation of issuing point based on the time measurement processing]. Furthermore, the time point issue history is recorded in the same manner as that described in the aforementioned [time point issue history data management process].

Here, for example, when the flag code corresponding to the “measurement end” is detected in the consumption condition parameter 7053, not only the detected time is obtained as the measurement end time Te by the dedicated application 4210, but also the first middle time Tp1 is made to correspond to the measurement starting time Ts and a time point Ep2 from the first middle time Tp1 to the measurement end time Te is calculated in the same manner as that described in the aforementioned [calculation of issuing point based on the time measurement processing]. Furthermore, the time point issue history is recorded in the same manner as that described in the aforementioned [time point issue history data management process].

Additionally, in the above-described embodiment, the time point is constantly issued according to all the driving times. However, as described above, the adjustment time Ct of the issuing condition parameter is adjusted by the difference between the driving time and a time required for the vehicle to travel at a speed limit without a traffic jam in each section. For example, when the difference is greater than a certain value, the adjustment time Ct of the issuing condition parameter is made to be reduced as much as the difference, so that the issued time point may be increased. Also, when the difference is less than a certain value, the adjustment time Ct of the issuing condition parameter is made to be increased as much as the difference, so that the issued time point may be decreased.

By the method described in the [predetermined consuming operation by the user], [time measurement processing based on the consuming operation] or [calculation of consumption point based on the time measurement processing], for example, the time point issued in this way is used (consumed) in the aforementioned “sales promotion time” provided by the particular store within the service area. The process described in the aforementioned [Time point consumption history data management process] is performed.

According to the above configuration, for example, more time points are issued to the user who drives at a speed limit in a congested highway while taking a proper break. As a result, it is possible to significantly improve order in road traffic.

Also, with reference to the foregoing first embodiment of the present invention, the location of the member store or affiliated store is obtained by the above-described location notifying device or location data. Also, a configuration can be considered in which the current location of the user is obtained by the aforementioned radio wave detector or the client device having the GPS function. For example, it is possible to easily plan a sales promotion service for issuing more time points to the user who visits the store from a long distance.

In such a plan, with reference to the configuration described in the [┌GPS link guide┘ providing method] or [time measurement processing by the GPS function], for example, when the user obtains the member store list or the affiliated store list from the ┌GPS link guide┘ of the “service menu” provided by the dedicated application of the client device and selects the member store which provides the sales promotion service, a form button of “visit from now” is provided to the guide of the selected member store. When the form button is submitted, the client location data and the identification information of the dedicated application at the time of submitting the form button are transmitted to the time management system, and not only the time measurement in which the transmitted client location data (Latitude Xc1, Longitude Yc1) is determined to be the aforementioned first tollgate of the highway begins, but also the measurement starting time Ts is obtained. When the user arrives at the member store, not only the time measurement is terminated at a time point, for example, the time measurement is terminated at a point of time when the location notifying device of the member store is detected by the client device or at a point of time when, within a predetermined range, the member store location data (Latitude Pxn, Longitude Pyn) of the member store matches the client location data (Latitude X2, Longitude Y2) at the user's arrival time point, but also the measurement end time Te is obtained. Such a plan can be easily implemented by the configuration for issuing the time point on the basis of the measurement starting time Ts and the measurement end time Te, thereby being helpful to regional revitalization.

### Embodiment 2

The second embodiment of the present invention features that the sales promotion point in a unit of time is a time point which is issued or consumed by measuring a predetermined elapsed period of time related to a particular operation of the user.

Time which is measured as the issuing condition of the sales promotion electronic point in a unit of time is not limited to the measurement starting time Ts and the measurement end time Te which are obtained by the dedicated application of the client device by using the location notifying device or the GPS function described in the aforementioned first embodiment, that is to say, is not limited to a predetermined elapsed period of time of the user at a particular place. The time which is measured as the issuing condition of the sales promotion electronic point can be obtained by measuring a predetermined elapsed period of time related to the particular operation of the user, for example, a time related to goods order from when the user orders goods in a net shop to when the goods reaches the user, a time related to an advertisement display from when the user clicks a video advertisement in a net advertisement to when the video advertisement is completed, or a time related to a game operation in a net game from when the user starts the game and to when the user completes the game.

Needless to say, in the aforementioned first embodiment, with regard to the calculation of the number of the issued time points or the number of the consumed time points which has been described in the [calculation of issuing point based on the time measurement processing] or [calculation of consumption point based on the time measurement processing], the calculation is not limited to the calculation by the point issuing program or the point consuming program of the dedicated application. For example, the calculation can be performed by installing the condition management program of the application server device, which constitutes the time management system having the equivalent calculation function to that of the point issuing program or the point consuming program.

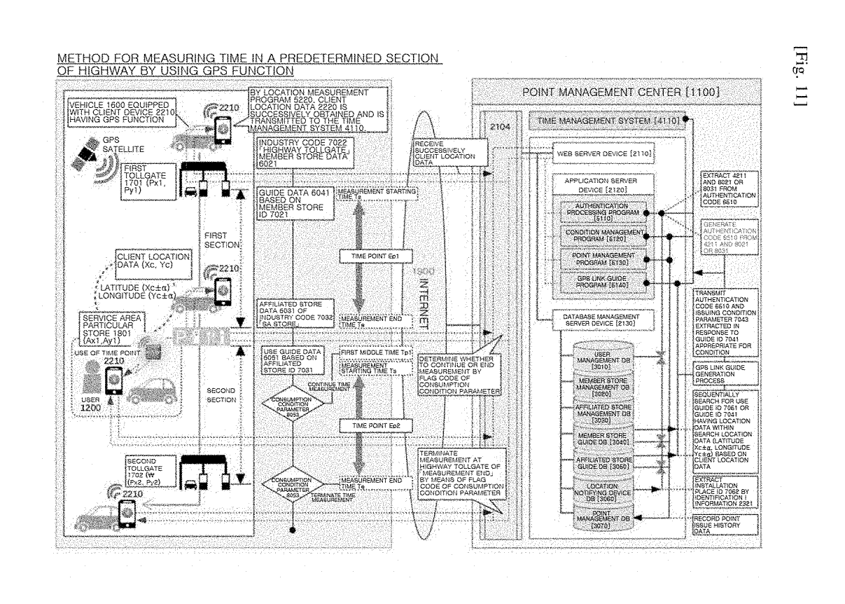

In this case, first, a method for measuring the time related to the goods order in a net shop is as follows. As shown in the outline view of FIG. 12, the user's client device, an EC system 4310 of the net shop, and the time management system 4110 of the point management center 1100 are connected to a Web network through the Internet 1900. Also, in a configuration in which a time measurement parameter 7311 corresponding to the time setting parameter 7231 of the point issuing program 5230 constituting the dedicated application 4210 described in the first embodiment is transmitted and received between the time management system 4110 and the EC system 4310 of the net shop by an email or a known Web-application programming interface (API), for example, when the user clicks an “order” button to determine the goods order for the net shop, order information on the goods order is obtained by the EC system 4310 of the net shop. When the obtained time is set as the measurement starting time Ts in the starting time field of the time measurement parameter 7311, the measurement starting time Ts is obtained in the time management system 4110 through the Internet 1900. The net shop delivers the order goods to the user by using a parcel delivery service. For example, when a delivery completion notice is transmitted from a delivery system 4420 of the parcel delivery service to the EC system 4310 of the net shop, the delivery completion notice is obtained by the EC system 4310 of the net shop. When the obtained time is set as the measurement end time Te in the end time field of the time measurement parameter 7311, the measurement end time Te is obtained in the time management system 4110 through the Internet 1900, and then the time related to the goods order in the net shop can be measured.

Here, with regard to the Web-API, at the time of filing the present application, for example, ITpro (http://itpro.nikkeibp.co.jp/article/Keyword/20070829/280600/) of Nikkei computer describes that “Web-API is a technology for efficiently developing a Web site, etc.”, “API stands for Application Programming Interface and is a means for allowing an application developer to use a function provided by another hardware or software”, “Web-API is an API that can be used via Internet for the purpose of developing a Web site, etc.”, and “Web-API is a technology for a side that opens the API and a side that uses the API to exchange instructions or data, and a technology called SOAP or REST is used. Web-API uses a protocol such as HTTP, etc., and has a structure for exchanging XML type data. Flexibility that does not require a particular environment for developing or using is one of its characteristics, because the Web-API uses such an Internet standard technology.” Also, it is described as below in Google MapsAPI web service (haps://developers.google.com/maps/documentation/webservices/?hl=ja).

“What is a web service?

The Google Maps API provides these web services as an interface for requesting Maps API data from external services and using them within your Maps applications. These services are designed to be used in conjunction with a map, as per the Maps API Terms of Service License Restrictions.

These web services use HTTP requests to specific URLs, passing URL parameters as arguments to the services. Generally, these services return data in the HTTP request as either JSON or XML for parsing and/or processing by your application.

A typical web service request is generally of the following form:

http://maps.googleapis.com/maps/api/service/output?parameters

where service indicates the particular service requested and output indicates the response format (usually json or xml).

### Obtainment of the Measurement Time by Web-API

Such a known Web-API technology is used. Also, for example, as shown in the outline view of FIG. 12, “shop_id” is made to correspond as a parameter for Web-API to the member store ID 7021 (FIG. 16) of the net shop determined to be the member store described in the aforementioned first embodiment, and “ecsys_id” is made to correspond as a parameter for Web-API to the identification information 2321 (FIG. 20) of the EC system 4310 of the net shop determined to be the location notifying device described in the first embodiment. Also, “user_id” is made to correspond as a parameter for Web-API to the user ID 7011 (FIG. 15) of the user of the net shop determined to be the user 1200 described in the first embodiment, and furthermore, “1sttime” is made to correspond as a parameter for Web-API to the measurement starting time Ts, i.e., the obtainment time of the order information in the EC system 4310, and “2ndtime” is made to correspond as a parameter for Web-API to the measurement end time Te, i.e., the obtainment time of the delivery completion notice in the EC system 4310. In this case, from the EC system 4310 through the parameters for Web-API, the time management system 4110 is able to easily obtain the value of the “1sttime” as the value of the starting time field of the time measurement parameter 7311 and able to easily obtain the value of the “2ndtime” as the value of the end time field of the time measurement parameter 7311.

Specifically, as shown in FIG. 12, for example, a Web-API corresponding program 5150 which has been developed by a known HTML and a programming language such as JavaScript, PHP, Perl, Java, C, C++ or the like is installed on the application server device 2120 constituting the time management system 4110. First, when the order information by the EC system 4310 of the net shop is obtained, an XML code on the value of the “shop_id” corresponding to the member store ID 7021 of the net shop determined to be the member store 1300, on the value of the “ecsys_id” corresponding to the identification information 2321 of the EC system 4310 determined to be the location notifying device 2320, on the value of the “user_id” corresponding to the user ID 7011 of the net shop user determined to be the user 1200, and on the value of the “1sttime” corresponding to the obtainment time of the order information, i.e., the measurement starting time Ts is output on the basis of the specification defined by the time management system 4110. Also, when the delivery completion notice is obtained by the EC system 4310, an XML code on the value of the “user_id” corresponding to the user ID 7011 and on the value of the “2ndtime” corresponding to the obtainment time of the delivery completion notice, i.e., the measurement end time Te is output on the basis of the specification defined by the time management system 4110. Sequentially, the same process as that described above is applied to other users. For example, as shown in (Z) of FIG. 12, the following “XML file (netshop-01.xml) for net shop” is provided by being temporarily saved in a storage device or memory, etc., in the EC system 4310 of the net shop.

```
    <?xml ver=““netshop api 1.0”” ?>
    <shop>
    <timedata>
    <shop_id>pt01001(※member store ID 7021 of net shop)</shop_id>
    <ecsys_id>wp01001(※identification information 2321 of EC system
    4310)</ecsys_id>
    <user_id>us00001(※user ID 7011 of net shop user)</user_id>
    <1sttime>20141010180101(※obtainment time of order information =
measurement starting time Ts)</1sttime>
    <2ndtime>20141011120101(※obtainment time of the delivery
completion notice= measurement end time Te)</2ndtime>
    </timedata>
    .....
    <timedata>
    <shop_id>pt01001</shop_id>
    <ecsys_id>wp01001</ecsys_id>
    <user_id>us00102(※relates to the next user)</user_id>
    <1sttime>20141015201010</1sttime>
    <2ndtime>20141017101515</2ndtime>
    </timedata>
    .....
    </shop>
```

Here, in the time management system 4110, for example, as shown in (Y) of FIG. 12, when the Web-API corresponding program 5150 which includes the following “Web-API code for net shop” developed by a known HTML and JavaScript is executed regularly or frequently,

```
// ---------------
// HTML
// ---------------
  <div id=““timedata””>
  <ul></ul>
  </div>
// ---------------
// JavaScript
// ---------------
$(function( ){
    $.ajax({
      url:‘http://www.netshop.com/api/netshop-01.xml’,
      type:‘GET’,
      dataType:‘xml’,
      timeout:1000,
      error:function( ) {
          alert(““loading error !!!””);
      },
      success:function(xml){
        $(xml).find(““timedata””).each(function( ) {
        $(““#timedata ul””).append(‘<li> +
        $(this).find(‘shop_id’).text( ) +
        $(this).find(‘ecsys_id’).text( ) +
        $(this).find(‘user_id’).text( ) +
        $(this).find(‘1sttime’).text( ) +
        $(this).find(‘2ndtime’).text( ) +
        ‘</li>’);
      });
    }
  });
});
```

the measurement starting time Ts and the measurement end time Te are regularly or frequently obtained by the “1sttime” and “2ndtime” respectively in the time management system 4110.

As shown in FIG. 12, with regard to the time point based on the obtained measurement starting time Ts and the measurement end time Te in the time management system 4110, the guide data 6041 composed of the issuance target data 7042 and the issuing condition parameter 7043 is extracted from the member store guide database 3040 (FIG. 18) on the basis of the identification information 2321 of the EC system 4310 determined to be the location notifying device 2320 by the aforementioned configuration, that is to say, the condition management program 5120 of the time management system 4110, which has the equivalent calculation function to that of the point issuing program 5230 or the point consuming program 5240 of the dedicated application 4210. Also, the time point is calculated in the same calculation method as that described in the [calculation of issuing point based on the time measurement processing] of the first embodiment on the basis of the issuing condition parameter 7043 and the target time data 8042 set in the issuance target data 7042. Furthermore, the point issue history data composed of the user ID 7011 of the user, the identification information 2321 of the EC system 4310, and the number of the issued time points is recorded in the point management database 3070 (FIG. 21) in the same recording method as that of the point issue history data described in the [time point issue history data management process] of the first embodiment.

Also, the information on the time point issued in this way can be simply provided to the user of the net shop by the following Web-API code.

Specifically, the information on the time point can be provided by, for example, adding the following code using the aforementioned typical web service request shown in (X) of FIG. 12 to a Web page of the net shop provided to the user by the EC system 4310, that is to say, to an HTML resource, and by making it possible to access the time management system 4110 in which the Web-API corresponding program 5150 has been installed.

The information on the time point can be also provided by adding the following code using

```
http://timeserver.adazro.com/api/timewallet/Search?key=
TimePoint&user_id=us00001&shop_id=pt01001 or JavaScript.
      <script
type=““text/JavaScript””src=““http://timeserver.adazro.com/api/
timewallet/Search?key=TimePoint&user_id=us00001&shop_id=
pt01001””>
        </script>
```

In addition, for example, with respect to the time management system 4110 designated by “timeserver.adazero.com”, the Web-API corresponding program 5150 called “timewallet” in “api/” is executed, and “us00001” is assigned to the user ID 7011. Also, “pt00001” is assigned to the member store ID 7021 of the member store 1300, so that the code corresponds to the web service request which requires information on “key=TimePoint.”

Also, as shown in FIG. 12, with regard to a method for obtaining the measurement end time Te in the time management system 4110, when the user is made to possess the client device 2210 which is a mobile terminal described in the first embodiment, such as a smartphone (mobile phone), a tablet PC, etc., including the known GPS function and the known radio wave detector detecting the Bluetooth-standardized radio wave and which has the dedicated application installed thereon that is composed of the reception measurement program which measures time while monitoring the radio wave reception state of the radio wave detector, the location measurement program which obtains the positioning data of the current location measured by the GPS function and measures time, and the point issuing program which manages the issuance of the time point, or the point consuming program which manages the consumption of the time point, and when a delivery man of the parcel delivery service is made to possess the location notifying device, the delivery man of the parcel delivery service corresponds to the member store and the location notifying device possessed by the delivery man corresponds to the location notifying device 2320 of member store. Therefore, as described above, the measurement end time Te can be simply obtained without passing through the delivery system 4220 of the parcel delivery service and the EC system 4310 of the net shop.

In this case, a time when the identification information 2321 of the location notifying device 2320 and the identification information 4211 of the dedicated application 4210, which are transmitted by the dedicated application 4210, are received as described with reference to FIG. 3 in the [predetermined consuming operation by the user] of the first embodiment is obtained as the measurement end time Te by the time management system 4110.

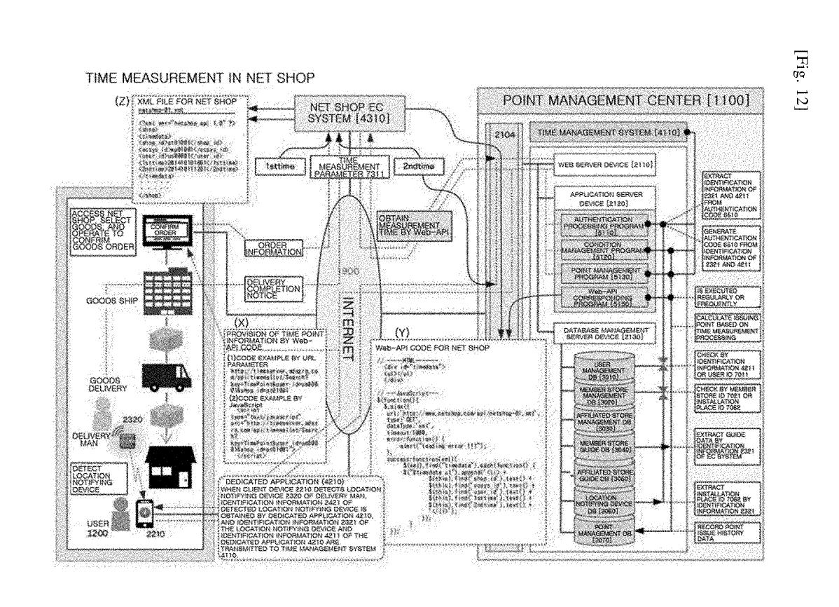

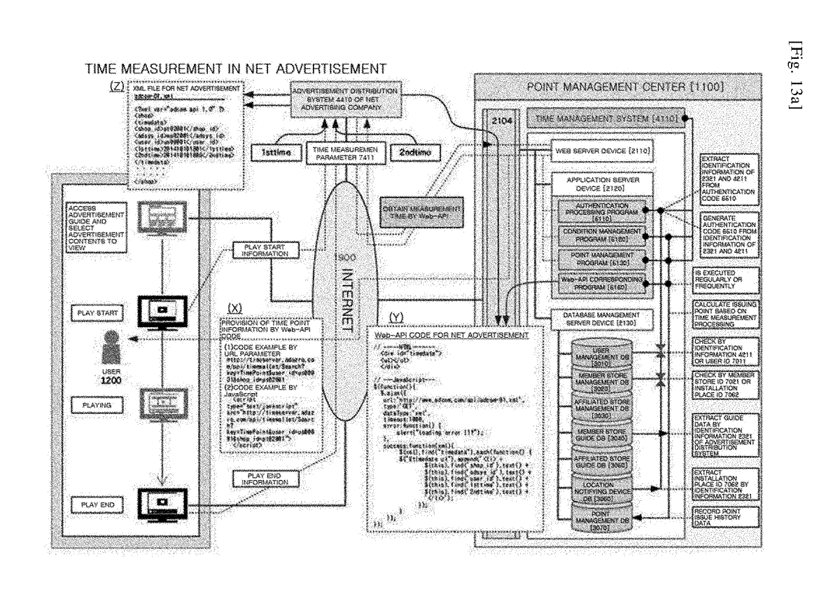

Next, with regard to a method for measuring a time related to the advertisement display in a net advertisement, as shown in the outline view of FIG. 13a, the client device of the user, an advertisement distribution system 4410 of a net advertising company, and the time management system 4110 of the point management center 1100 are connected to a Web network through the Internet 1900. Also, in a configuration in which a time measurement parameter 7411 corresponding to the time setting parameter 7231 of the point issuing program 5230 constituting the dedicated application 4210 is transmitted and received between the time management system 4110 and the advertisement distribution system 4410 of the net advertising company by an email or the method described in the [obtainment of the measurement time by Web-API], etc., for example, when the user clicks a “play start” button to represent that a video advertisement distributed by the advertisement distribution system 4410 is played, play start information of the video advertisement is obtained by the advertisement distribution system 4410 of the net advertising company. When the obtained time is set as the measurement starting time Ts in the starting time field of the time measurement parameter 7411, the measurement starting time Ts is obtained in the time management system 4110 through the Internet 1900. When the play of the video advertisement is ended in the user's client device, play end information of the video advertisement is obtained by the advertisement distribution system 4410 of the net advertising company. When the obtained time is set as the measurement end time Te in the end time field of the time measurement parameter 7411, the measurement end time Te is obtained in the time management system 4110 through the Internet 1900, so that the time related to the advertisement display can be measured.

Specifically, as shown in FIG. 13a, for example, the Web-API corresponding program 5150 is installed on the application server device 2120 constituting the time management system 4110. First, when the play start information is obtained by the advertisement distribution system 4410 of the net advertising company, an XML code on the value of the “shop_id” corresponding to the member store ID 7021 (FIG. 16) of the net adverting company determined to be the member store 1300, on the value of the “adsys_id” corresponding to the identification information 2321 (FIG. 20) of the advertisement distribution system 4410 determined to be the location notifying device 2320, on the value of the “user_id” corresponding to the user ID 7011 (FIG. 15) of the user watching the advertisement of the net advertising company determined to be the user 1200, and on the value of the “1sttime” corresponding to the obtainment time of the play start information, i.e., the measurement starting time Ts is output on the basis of the specification defined by the time management system 4110. Also, when the play end information is obtained by the advertisement distribution system 4410, an XML code on the value of the “user_id” corresponding to the user ID 7011 and on the value of the “2ndtime” corresponding to the obtainment time of the play end information, i.e., the measurement end time Te is output on the basis of the specification defined by the time management system 4110. Sequentially, the same process as that described above is applied to other users. For example, “XML file (adcom-01.xml) for net advertising company” shown in (Z) of FIG. 13b is provided by being temporarily saved in a storage device or memory, etc., in the advertisement distribution system 4410 of the net advertising company.

Here, in the time management system 4110, for example, when the Web-API corresponding program 5150 including “Web-API code for net advertising company” shown in (Y) of FIG. 13b is regularly or frequently executed, the measurement starting time Ts and the measurement end time Te are regularly or frequently obtained by the “1sttime” and “2ndtime” respectively in the time management system 4110.

As shown in FIG. 13a, with regard to the time point based on the obtained measurement starting time Ts and the measurement end time Te in the time management system 4110, as described above, the guide data 6041 composed of the issuance target data 7042 and the issuing condition parameter 7043 is extracted from the member store guide database 3040 (FIG. 18) on the basis of the identification information 2321 of the EC system 4310 determined to be the location notifying device 2320 by the condition management program 5120 of the time management system 4110. Also, the time point is calculated in the same calculation method as that described in the aforementioned [calculation of issuing point based on the time measurement processing] on the basis of the issuing condition parameter 7043 and the target time data 8042 set in the issuance target data 7042. Furthermore, the point issue history data composed of the user ID 7011 of the user, the identification information 2321 of the EC system 4310, and the number of the issued time points is recorded in the point management database 3070 (FIG. 21) in the same recording method as that of the point issue history data described in the aforementioned [time point issue history data management process].

The information on the time point issued in this way can be simply provided to the user watching the advertisement of the net advertising company by the Web-API code shown in “provision of the time point information by the Web-API code” of (X) of FIG. 13a.

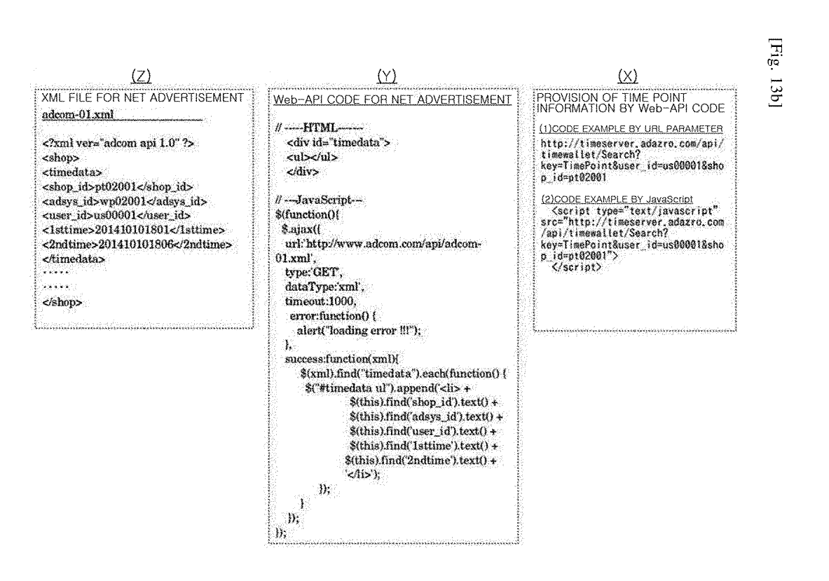

Furthermore, with regard to a method for measuring a time related to a game operation in a net game, as shown in the outline view of FIG. 14a, the client device of the user, a game system 4510 of a net game company, and the time management system 4110 of the point management center 1100 are connected to a Web network through the Internet 1900. Also, in a configuration in which a time measurement parameter 7511 corresponding to the time setting parameter 7231 of the point issuing program 5230 constituting the dedicated application 4210 is transmitted and received between the time management system 4110 and the game system 4510 of the net game company by an email or the method described in the [obtainment of the measurement time by Web-API], etc., for example, when the user clicks a “start” button to represent that the play of the game provided by the game system 4510 is started, start information of the game is obtained by the game system 4510 of the net game company. When the obtained time is set as the measurement starting time Ts in the starting time field of the time measurement parameter 7511, the measurement starting time Ts is obtained in the time management system 4110 through the Internet 1900. When the play of the game is over in the user's client device, game over information of the game is obtained by the game system 4510 of the net game company. When the obtained time is set as the measurement end time Te in the end time field of the time measurement parameter 7511, the measurement end time Te is obtained in the time management system 4110 through the Internet 1900, so that the time related to the game operation can be measured.

Specifically, as shown in FIG. 14a, for example, the Web-API corresponding program 5150 is installed on the application server device 2120 constituting the time management system 4110. First, when the start information is obtained by the game system 4510 of the net game company, an XML code on the value of the “shop_id” corresponding to the member store ID 7021 (FIG. 16) of the net game company determined to be the member store 1300, on the value of the “gmsys_id” corresponding to the identification information 2321 (FIG. 20) of the game system 4510 determined to be the location notifying device 2320, on the value of the “user_id” corresponding to the user ID 7011 (FIG. 15) of the user playing the game of the net game company determined to be the user 1200, and on the value of the “1sttime” corresponding to the obtainment time of the start information, i.e., the measurement starting time Ts is output on the basis of the specification defined by the time management system 4110. Also, when the game over information is obtained by the game system 4510, an XML code on the value of the “user_id” corresponding to the user ID 7011 and on the value of the “2ndtime” corresponding to the obtainment time of the game over information, i.e., the measurement end time Te is output on the basis of the specification defined by the time management system 4110. Sequentially, the same process as that described above is applied to other users. For example, “XML file (gmcom-01.xml) for net game” shown in (Z) of FIG. 14b is provided by being temporarily saved in a storage device or memory, etc., in the game system 4510 of the net game company.

Here, in the time management system 4110, for example, when the Web-API corresponding program 5150 including “Web-API code for net game” shown in (Y) of FIG. 14b is regularly or frequently executed, the measurement starting time Ts and the measurement end time Te are regularly or frequently obtained by the “1sttime” and “2ndtime” respectively in the time management system 4110.

As shown in FIG. 14a, with regard to the time point based on the obtained measurement starting time Ts and the measurement end time Te in the time management system 4110, as described above, the guide data 6041 composed of the issuance target data 7042 and the issuing condition parameter 7043 is extracted from the member store guide database 3040 (FIG. 18) on the basis of the identification information 2321 of the EC system 4310 determined to be the location notifying device 2320 by the condition management program 5120 of the time management system 4110. Also, the time point is calculated in the same calculation method as that described in the aforementioned [calculation of issuing point based on the time measurement processing] on the basis of the issuing condition parameter 7043 and the target time data 8042 set in the issuance target data 7042. Furthermore, the point issue history data composed of the user ID 7011 of the user, the identification information 2321 of the EC system 4310, and the number of the issued time points is recorded in the point management database 3070 in the same recording method as that of the point issue history data described in the aforementioned [time point issue history data management process].

The information on the time point issued in this way can be simply provided to the user playing the game of the net game company by the Web-API code shown in “provision of the time point information by the Web-API code” of (X) of FIG. 14b.

Lastly, the time point of the present invention is the sales promotion point that is issued or consumed in a unit of time which is a physical relative value. If the time point can be distributed as a world-wide sales promotion point in no consideration of the conversion rate such as an exchange rate and without paying an expensive system cost described above, it is possible to greatly expect a communication tool effect as well as a sales promotion effect.

1. A method for controlling a time point distribution management network/system for distributing an electronic sales promotion point in a unit of time by a Web client/server system using an internet communication,
wherein a server system which is used in the time point distribution management network/system is a time management system which comprises not only a database for managing a user, the time point, and a time measurement place, but also an authentication processing program for authorizing the user and the time measurement place, a point management program for managing a time point issue history or a time point consumption history, and a condition management program for managing a time point issuing condition or a time point consumption condition,
wherein a client device which is used in the time point distribution management network/system has a function of a general-purpose computer on which a dedicated application composed of a reception measurement program for performing a time measurement while detecting the time measurement place, a point issuing program for performing an issuance of the time point, and a point consuming program for performing a consumption of the time point has been installed,
wherein, through the internet communication between the time management system and the client device, the method for controlling a time point distribution management network/system comprises:
(a) providing the user with information on a member store issuing the time point, the time point issuing condition of the member store, information on an affiliated store in which the time point is consumed, or the time point consumption condition of the affiliated store;
(b) issuing the time point on the basis of the issuing condition in accordance with a predetermined elapsed period of time of the user in the member store;
(c) accepting the consumption of the time point on the basis of the consumption condition in accordance with a predetermined sales promotion time of the user in the affiliated store;
(d) processing the issuance or consumption of the time point, or managing the time point issue history or the time point consumption history; and
(e) providing the user with information on the time point that the user possesses,
and wherein the predetermined elapsed period of time of the user in the member store is measured by the dedicated application while monitoring a radio wave, which is transmitted from a location notifying device installed in the member store, by means of a radio wave detector of the client device, and the issuing condition of the member store is a condition that the time point whose issue number is based on the same unit as a unit of the time measured by the dedicated application is issued.

2. The method of claim 1, wherein the time point which is issued by the issuing condition of the member store is consumed on the basis of the consumption condition calculated by a sale price of the affiliated store with respect to the predetermined sales promotion time in the affiliated store.

3. The method of claim 1, wherein the client device is equipped with a GPS receiver and wherein a location measurement program is added to a program constituting the dedicated application which is installed on the client device, so that the predetermined elapsed period of time of the user in the member store is measured by the dedicated application while obtaining a positioning data of a current location based on a GPS function.

4. The method of claim 1, wherein one or both of the member store and the affiliated store is a net-based service provider which operates a Web service system, and wherein not only a predetermined elapsed period of time related to a particular operation of the user for the Web service system is measured by a Web-API exchange between the Web service system and the time management system, but also the time point is issued or consumed on the basis of the measured time.

5. The method of claim 4, wherein the predetermined elapsed period of time related to a particular operation of the user is an elapsed time period from an order time for an order operation for a net shop by the user to an arrival time of an ordered goods.

6. The method of claim 4, wherein the predetermined elapsed period of time related to a particular operation of the user is an elapsed time period from a play start time for a play operation for a net game by the user to a play end time.

7. The method of claim 4, wherein the predetermined elapsed period of time related to a particular operation of the user is an elapsed time period from a view start time for a view operation for a net advertisement by the user to a view end time.

8. The method of claim 1, wherein the client device is equipped with a radio wave detector having a location detection function, and wherein a location of the client device is detected by the location detection function of the radio wave detector of the client device.

9. A method for controlling a time point distribution management network/system for distributing an electronic sales promotion point in a unit of time by a Web client/server system using an internet communication by using a client device,
wherein the client device has a function of a general-purpose computer on which a dedicated application composed of a reception measurement program for performing a time measurement while detecting a time measurement place, a point issuing program for performing an issuance of the time point, and a point consuming program for performing a consumption of the time point has been installed,
wherein the method for controlling a time point distribution management network/system comprises:
(a) providing a user with information on a member store issuing the time point, a time point issuing condition of the member store, information on an affiliated store in which the time point is consumed, or a time point consumption condition of the affiliated store;
(b) issuing the time point on the basis of the issuing condition in accordance with a predetermined elapsed period of time of the user in the member store; and
(c) providing the user with information on the time point that the user possesses,
and wherein the predetermined elapsed period of time is measured by the dedicated application while monitoring a radio wave, which is transmitted from a location notifying device installed in the member store, by means of a radio wave detector of the client device, and the issuing condition is a condition that the time point whose issue number is based on the same unit as a unit of the time measured by the dedicated application is issued.

10. The method of claim 9, wherein the time point which is issued by the issuing condition of the member store is consumed on the basis of the consumption condition calculated by a sale price of the affiliated store with respect to the predetermined sales promotion time in the affiliated store.

11. The method of claim 9, wherein the client device is equipped with a GPS receiver and wherein a location measurement program is added to a program constituting the dedicated application which is installed on the client device, so that the predetermined elapsed period of time in the member store is measured by the dedicated application while obtaining a positioning data of a current location based on a GPS function.

12. The method of claim 9, wherein one or both of the member store and the affiliated store is a net-based service provider which operates a Web service system, and wherein not only the predetermined elapsed period of time is measured by a Web-API exchange between the Web service system and the time management system, i.e., an external server, but also the time point is issued or consumed on the basis of the measured time.

13. A method for controlling a time point distribution management network/system for distributing an electronic sales promotion point in a unit of time by using a server system,
wherein the server system comprises not only a database for managing a user, the time point, and a time measurement place, but also an authentication processing program for authorizing the user and the time measurement place, a point management program for managing a time point issue history or a time point consumption history, and a condition management program for managing a time point issuing condition or a time point consumption condition,
wherein the method for controlling a time point distribution management network/system comprises:
(a) providing the user with information on a member store issuing the time point, the time point issuing condition of the member store, information on an affiliated store in which the time point is consumed, or the time point consumption condition of the affiliated store;
(b) issuing the time point on the basis of the issuing condition in accordance with a predetermined elapsed period of time of the user in the member store;
(c) accepting the consumption of the time point on the basis of the consumption condition in accordance with a predetermined sales promotion time of the user in the affiliated store;
(d) processing the issuance or consumption of the time point, or managing the time point issue history or the time point consumption history; and
(e) providing the user with information on the time point that the user possesses,
and wherein the predetermined elapsed period of time of the user in the member store is measured by a dedicated application while monitoring a radio wave, which is transmitted from a location notifying device installed in the member store, by means of a radio wave detector of a client device, and the issuing condition of the member store is a condition that the time point whose issue number is based on the same unit as a unit of the time measured by the dedicated application is issued.

14. The method of claim 13, wherein one or both of the member store and the affiliated store is a net-based service provider which operates a Web service system, and wherein not only a predetermined elapsed period of time related to a particular operation of the user for the Web service system is measured by a Web-API exchange between the Web service system and the time management system, but also the time point is issued or consumed on the basis of the measured time.

15. The method of claim 14, wherein the predetermined elapsed period of time related to a particular operation of the user is an elapsed time period from an order time for an order operation for a net shop by the user to an arrival time of an ordered goods.

16. The method of claim 14, wherein the predetermined elapsed period of time related to a particular operation of the user is an elapsed time period from a play start time for a play operation for a net game by the user to a play end time.

17. The method of claim 14, wherein the predetermined elapsed period of time related to a particular operation of the user is an elapsed time period from a view start time for a view operation for a net advertisement by the user to a view end time.

18. The method of claim 13, wherein the time point which is issued by the issuing condition of the member store is consumed on the basis of the consumption condition calculated by a sale price of the affiliated store with respect to the predetermined sales promotion time in the affiliated store.

19. A time point issuing method for distributing an electronic sales promotion point in a unit of time by a Web client/server system using an internet communication,
wherein a server system which is used in the time point distribution management network/system is a time management system which comprises not only a database for managing a user, the time point, and a time measurement place, but also an authentication processing program for authorizing the user and the time measurement place, a point management program for managing a time point issue history, and a condition management program for managing a time point issuing condition,
wherein a client device which is used in the time point distribution management network/system has a function of a general-purpose computer on which a dedicated application composed of a reception measurement program for performing a time measurement while detecting the time measurement place, and a point issuing program for performing an issuance of the time point has been installed,
wherein, through the internet communication between the time management system and the client device, the method for distributing an electronic sales promotion point comprises:
(a) providing the user with information on a member store issuing the time point, or the time point issuing condition of the member store;
(b) issuing the time point on the basis of the issuing condition in accordance with a predetermined elapsed period of time of the user in the member store;
(c) processing the issuance of the time point, or managing the time point issue history; and
(d) providing the user with information on the time point that the user possesses,
and wherein the predetermined elapsed period of time of the user in the member store is measured by the dedicated application while monitoring a radio wave, which is transmitted from a location notifying device installed in the member store, by means of a radio wave detector of the client device, and the issuing condition of the member store is a condition that the time point whose issue number is based on the same unit as a unit of the time measured by the dedicated application is issued.

20. The time point issuing method of claim 19, wherein the client device is equipped with a GPS receiver and wherein a location measurement program is added to a program constituting the dedicated application which is installed on the client device, so that the predetermined elapsed period of time of the user in the member store is measured by the dedicated application while obtaining a positioning data of a current location based on a GPS function.

21. The time point issuing method of claim 19, wherein one or both of the member store and the affiliated store is a net-based service provider which operates a Web service system, and wherein not only a predetermined elapsed period of time related to a particular operation of the user for the Web service system is measured by a Web-API exchange between the Web service system and the time management system, but also the time point is issued on the basis of the measured time.

22. The time point issuing method of claim 21, wherein the predetermined elapsed period of time related to a particular operation of the user is an elapsed time period from an order time for an order operation for a net shop by the user to an arrival time of an ordered goods.

23. The time point issuing method of claim 21, wherein the predetermined elapsed period of time related to a particular operation of the user is an elapsed time period from a play start time for a play operation for a net game by the user to a play end time.

24. The time point issuing method of claim 21, wherein the predetermined elapsed period of time related to a particular operation of the user is an elapsed time period from a view start time for a view operation for a net advertisement by the user to a view end time.

25. The time point issuing method of claim 19, wherein the client device is equipped with a radio wave detector having a location detection function, and wherein a location of the client device is detected by the location detection function of the radio wave detector of the client device.

26. A time point consuming method for distributing an electronic sales promotion point in a unit of time by a Web client/server system using an internet communication,
wherein a server system which is used in the time point distribution management network/system is a time management system which comprises not only a database for managing a user, the time point, and a time measurement place, but also an authentication processing program for authorizing the user and the time measurement place, a point management program for managing a time point consumption history, and a condition management program for managing a time point consumption condition,
wherein, through the internet communication between the time management system and the client device, the method for distributing an electronic sales promotion point comprises:
(a) providing the user with information on an affiliated store in which the time point is consumed, or the time point consumption condition of the affiliated store;
(b) accepting the consumption of the time point on the basis of the consumption condition in accordance with a predetermined sales promotion time of the user in the affiliated store;
(c) processing the consumption of the time point, or managing the time point consumption history; and
(d) providing the user with information on the time point that the user possesses.

27. The time point consuming method of claim 26, wherein the time point is consumed on the basis of the consumption condition calculated by a sale price of the affiliated store with respect to the predetermined sales promotion time in the affiliated store.

28. A time point issuing method for distributing an electronic sales promotion point in a unit of time by a Web client/server system using an internet communication,
wherein a server system which is used in the time point distribution management network/system is a time management system which comprises not only a database for managing a user, the time point, and a time measurement place, but also an authentication processing program for authorizing the user and the time measurement place, a point management program for managing a time point issue history, and a condition management program for managing a time point issuing condition,
wherein, through the internet communication between the time management system and the client device, the method for distributing an electronic sales promotion point comprises:
(a) providing the user with information on a member store issuing the time point, or the time point issuing condition of the member store;
(b) accepting an issuance the time point on the basis of the issuing condition in accordance with a predetermined elapsed period of time of the user in the member store;
(c) processing the issuance of the time point, or managing the time point issue history; and
(d) providing the user with information on the time point that the user possesses.

29. The time point issuing method of claim 28, wherein the predetermined elapsed period of time is measured on the basis of a sound wave which is transmitted from a location notifying device installed in the member store.

30. The time point issuing method of claim 29,
wherein the client device which is used in the time point distribution management network/system has a function of a general-purpose computer on which a dedicated application composed of a reception measurement program for performing a time measurement while detecting the time measurement place, and a point issuing program for performing an issuance of the time point has been installed,
and wherein the client device measures the predetermined elapsed period of time through the dedicated application while monitoring the sound wave which is transmitted from the location notifying device.

31. The time point issuing method of claim 30, wherein the issuing condition is a condition that the time point whose issue number is based on the same unit as a unit of the time measured by the dedicated application is issued.
